(19) United States
(12) Patent Application Publication
(10) Pub. No.: US 2020/0277174 A1
(43) Pub. Date: Sep. 3, 2020

(54) HAND LIFT DEVICE

(71) Applicant: Sang Uk Park, Seoul (KR)

(72) Inventor: Sang Uk Park, Seoul (KR)

(21) Appl. No.: 16/301,416

(22) PCT Filed: Sep. 20, 2018
(86) PCT No.: PCT/KR18/11174

§ 371 Date: Dec. 20, 2018

(30) Foreign Application Priority Data
Jun. 7, 2018 (KR) 10-2018-0065351
Jun. 29, 2018 (KR) 10-2018-0075337
Jun. 29, 2018 (KR) 10-2018-0075822
Sep. 12, 2018 (KR) 10-2018-0109239
Sep. 12, 2018 (KR) 10-2018-0109240
Sep. 12, 2018 (KR) 10-2018-0109242

(51) Int. Cl. B66F 9/08; B66F 9/07; B66F 9/075; B66F 9/18; B66F 9/20

(52) U.S. Cl. CPC B66F 9/087; B66F 9/07; B66F 9/24; B66F 9/18; B66F 9/20; B66F 9/0759

(57) ABSTRACT

According to an embodiment of the present invention, there is provided a hand lift device including: a frame portion including a vertical frame, a first sprocket installed on an upper end of the vertical frame, and a second sprocket installed on a lower end of the vertical frame; a chain installed to engage with the first sprocket and the second sprocket; a cargo loading unit which is connected with the chain and disposed to be liftable along the vertical frame to load cargo; a power transmission portion which provides a driving force to the chain so that the cargo loading unit is lifted up and down; a sensor portion which is installed in an area where the frame portion is formed to be positioned at an upper side in a range where the cargo loading unit is lifted up and down and includes a proximity sensor to sense the cargo loaded on the cargo loading unit; and a controller which controls lifting up and down of the cargo loading unit by adjusting the driving of the power transmission portion according to a sensing signal from the sensor portion.

According to the embodiment of the present invention, since the operator can automatically load the cargo by controlling through the cargo loading unit without manually loading the cargo, the hand lift device can operate faster than manual operation, load more cargo over the same time, and operate with a small number of persons, thereby reducing the cost.

### TECHNICAL FIELD

The present invention relates to a hand lift device and more particularly, to a hand lift device capable of loading boxed cargo.

### BACKGROUND ART

In general, a hand lift device (a hand truck, a deck truck, etc.) is intended to load and carry heavy cargo. In the hand lift device, a method of loading the cargo on a loading plate, laying the loading plate at a certain angle and then carrying the cargo to a certain distance by using wheels, and a method of lifting up and down the loading plate for loading the cargo are used.

In a hand lift device in the related art, there is a problem in that an operator needs to load cargo by bending the body when loading the cargo on a loading plate that initially descends to the bottom in a process of loading multiple cargo on the loading plate and bends or stretches the body while loading the cargo in sequence to damage the body. On the other hand, there is also a problem in that even when the multiple cargo loaded on the loading plate of the hand lift device is unloaded, the operator bends or stretches the body to transfer the cargo.

In addition, the hand lift device needs to be laid down at a certain angle to carry the multiple loaded cargo, but due to the weight of the multiple cargo loaded on the hand lift device, the old and the infirm such as women are not easy to lay at a certain angle or directly stand the hand lift device.

As a prior art related with the present invention, Prior Art 1 discloses a hand truck capable of stably moving upward or downward cargo by rotatably climbing a climbing unit through internal power at a place where steps are formed at a regular height, such as stairs while moving in a stable structure by wheels and a climbing auxiliary unit in a flatland when moving cargo loaded on the hand truck. In the Prior Art 1, when the cargo moves from a high position to a low position or from the low position to the high position, a lift unit is provided, but the disclosed hand truck has a disadvantage that the structure is complicated, a self-weight is large, and a manufacturing cost is high.

Further, as the prior art related with the present invention, Prior Art 2 discloses a hand car having a driving function of moving the hand car forward or backward by power of a motor and a lifting function of lifting up or down a loading plate.

In the Prior Art 2, when the cargo moves from a high position to a low position or from the low position to the high position, a lift unit is provided, but when high-weight cargo is placed on the loading plate, a structure for firmly supporting a chain that gives the lift function is not separately provided and thus there is a limit in the load stability.

### DISCLOSURE

### Technical Problem

The present invention has been made to solve the above problems, and an object of the present invention is to provide a hand lift device in which a cargo loading unit is automatically lifted up or down to maintain loaded cargo at a predetermined height by detecting a height of the cargo loaded on the cargo loading unit so that an operator can load or lift up the cargo without bending the body.

Another object of the present invention is to provide a hand lift device in which even when high-weight loaded cargo is loaded on the cargo loading unit, a means of adding tension to a chain for lifting up or down the cargo loading unit is provided to adjust the tension of the chain and enhance the loading stability.

Yet another object of the present invention is to provide a hand lift device in which the cargo loading unit is detachably configured and a detachment method is simply configured to deviate from an inconvenient detachment method such as a conventional screw coupling method, thereby improving convenience of the user.

The objects of the present invention are not limited to the aforementioned object, and other objects, which are not mentioned above, will be apparent to a person having ordinary skill in the art from the following description.

### Technical Solution

In order to achieve the above object, an exemplary embodiment of the present invention provides a hand lift device including: a frame portion including a vertical frame, a first sprocket installed on an upper end of the vertical frame, and a second sprocket installed on a lower end of the vertical frame; a chain installed to engage with the first sprocket and the second sprocket; a cargo loading unit which is connected with the chain and disposed to be liftable along the vertical frame to load cargo; a power transmission portion which provides a driving force to the chain so that the cargo loading unit is lifted up and down; a sensor portion which is installed in an area where the frame portion is formed to be positioned at an upper side in a range where the cargo loading unit is lifted up and down and includes a proximity sensor to sense the cargo loaded on the cargo loading unit; and a controller which controls lifting up and down of the cargo loading unit by adjusting the driving of the power transmission portion according to a sensing signal from the sensor portion.

The transmission portion may include an electric motor rotating forward and backward, and a driving shaft of the electric motor may provide a driving force to a rotational shaft of the second sprocket.

The cargo loading unit may include a loading member on which the cargo is loaded, a lifting member that lifts up and down along a guide rail formed on the vertical frame, and a coupling member that couples the loading member and the lifting member, and the chain may be connected to the lifting member and transmit a driving force from the power transmission portion to the cargo loading unit through the lifting member.

One end of the chain may be connected to the upper end of the lifting member, the other end of the chain may be connected to the lower end of the lifting member, and a chain tensioner providing the tension to the chain may be interposed in at least one point of points where the chain and the lifting member are connected.

The chain tensioner may be formed of a spring member in which both ends have a ring shape, one end is connected to the chain, and the other end is connected to the lifting member, or formed in an elastic structure which includes a support panel fastened to the lifting member, a chain connection portion of which one side is exposed outside the support panel through the support panel to be coupled to the chain and the other side is accommodated inside the lifting member, and a spring member elastically supporting the chain connection portion while being accommodated inside the lifting member, interposed between the chain connection portion and the support panel, and supported by the support panel.

The lifting member may include at least one protrusion, and the coupling member may include at least one engaging portion formed to engage with the protrusion.

The controller may control the driving of the power transmission portion to maintain a height of the upper end of the cargo loaded on the cargo loading unit at a predetermined height based on the sensing signal from the sensor portion.

The controller may control the lifting of the cargo loading unit by maintaining the driving of the power transmission portion when the cargo sensing signal is received from the sensor portion in the case of a load mode of driving the power transmission portion so that the cargo loading unit is lifted down, and stopping the driving of the power transmission portion when the cargo sensing signal is received from the sensor portion in the case of an unload mode of driving the power transmission portion so that the cargo loading unit is lifted up.

The sensor portion may further include a load cell which is installed on the cargo loading unit to sense the load of the cargo loaded on the cargo loading unit.

The hand lift device may further include a moving support portion which is detachably installed on the frame portion to support the frame portion and moves the frame portion to a predetermined position.

The moving support portion may include a frame support structure which has a slot which can accommodate a part of the frame portion therein to support the outer surface of the frame portion accommodated in the slot and is detachably coupled to the frame portion; support panels which are coupled to both ends of the frame support structure in a longitudinal direction of the frame support structure; wheels which are coupled to the support panels and are arranged behind the frame portion and perform rotational motion in a state of being grounded on the ground surface; and forks which are coupled to the support panel and disposed in front of the frame portion and have a caster at the end to switch the movement direction of the frame portion.

The support panel may be formed of a magnesium material, and the fork may be position-adjustable in a front-rear direction of the frame portion along the surface of the support panel.

The wheel may include a wheel motor which is coupled and supported to the support panel to generate a rotational force; and a wheel body which is rotatably coupled to the wheel motor and performs rotational motion through the rotational force transmitted from the wheel motor.

The hand lift device may further include a fixing support portion which is detachably installed on the frame portion and supported on the ground to support the frame portion in a direction perpendicular to the ground surface.

The fixing support portion may include a fixing panel formed in a flat plate and installed on the ground; and a vertical support frame which protrudes upward by a predetermined length in the vertical direction from the upper surface of the fixing panel to form a slot capable of accommodating a part of the frame portion therein and support the outer surface of the frame portion accommodated in the slot.

The vertical support frame may simultaneously support both side surfaces and the rear surface of the frame portion accommodated in the slot.

The hand lift device may further include a boarding portion which is installed on the frame portion and boardable while a user is standing or sitting.

The cargo loading unit may include a support frame which is installed on the frame portion to be lifted up and down; support arms which protrude from the end of the support frame in a predetermined length to form an accommodation space capable of accommodating the cargo therein and are disposed opposite to each other in the longitudinal direction of the support frame; and gripping blades which are rotatably installed on the support arms and disposed in the accommodation space in a horizontal state, and separated outwardly by rotating at a predetermined angle when the cargo is loaded and then retracted inwardly by an elastic force to support the outer surface of the cargo.

The support frame may include a vertical member which is installed on the frame portion; a horizontal member which is disposed horizontally below the vertical member and connected to the support arm to support the support arm; and a reinforcement member connecting the vertical member and the horizontal member.

The support arms may include a first arm disposed on one side of the horizontal member in a longitudinal direction of the horizontal member and a second arm disposed on the other side of the horizontal member in the longitudinal direction of the horizontal member, and the gripping blades may include a first blade rotatably installed on the first arm and a second blade rotatably installed on the second arm.

The first arm and the second arm may be coupled to the horizontal member in a detachable structure and relatively movable in the longitudinal direction of the horizontal member.

The support arms may be installed on the first arm and the second arm to support the first blade and the second blade, respectively, and further include grip space adjusting units which relatively move the first blade and the second blade to adjust a distance between the first blade and the second blade.

The grip space adjusting unit may include a guide rail provided on the upper surface of the support arm; a transport block provided on the guide rail and movable along the guide rail; a support bracket provided on the transport block and rotatably supporting the gripping blade; and a driving device which is provided on the upper surface of the support arm and coupled to the support bracket to move the support bracket.

When the cargo is unloaded, a distance between the first blade and the second blade may be smaller than a distance between the first blade and the outer surface of the cargo supported by the second blade.

The gripping blade may include a shaft portion rotatably coupled to the support arm; a blade body which extends from the shaft portion to one side to be disposed in the accommodation space and has a plurality of inclined guide surfaces formed on one side end and the other side end of the blade body in the longitudinal direction to guide the movement of the cargo when the cargo is loaded; and an elastic member which is provided around the shaft portion to elastically support the blade body and limits a rotational angle of the gripping blade.

The gripping blade may be rotatable at an angle of 0° to 90°.

The gripping blade may further include a guide roller which is installed on the end portion of the blade body and performs the rotational motion while being in contact with the outer surface of the cargo when the cargo is loaded.

The cargo loading unit may include a support frame which is installed on the frame portion to be lifted up and down; a driving portion which is installed on the support portion and extendable or contractible by performing linear motion in a horizontal direction; and a gripping portion which is rotatably coupled to both ends of the driving portion, forms an accommodation space capable of accommodating the cargo therein, and grips the cargo accommodated in the accommodation space by performing relative motion in the horizontal direction when the driving portion is driven.

The gripping portion may include a first support arm rotatably installed on one side of the driving portion; and a second support arm rotatably installed on the other side of the driving portion and disposed to face the first support arm to perform relative motion with respect to the first support arm.

The hand lift device may further include a cushioning portion provided on the support portion and supporting the gripping portion in the horizontal direction.

The cargo loading unit may include a support frame which is installed on the frame portion to be lifted up and down; a tongs-shaped gripping portion which is rotatably installed on the support portion to form an accommodation space therein and grips the cargo accommodated in the accommodation portion while being separated outwardly or retracted inwardly during rotating; and a driving portion which is installed on the support portion to be connected to the end portion of the gripping portion accommodated in the support portion and pushes outwardly or pulls inwardly the end portion of the gripping portion by performing linear motion to adjust a rotational angle of the gripping portion.

The cargo loading unit may include a support frame which is installed on the frame portion to be lifted up and down; a rotation portion installed on the support portion and rotatable clockwise or counterclockwise; a tongs-shaped gripping portion which is installed on the rotation portion to form an accommodation space therein and separated outwardly or retracted inwardly by rotation and presses and supports the outer surface of the cargo accommodated in the accommodation space; and a driving portion including a first angle adjusting unit which is installed on the rotation portion and transmits a rotational force to the gripping portion to adjust a rotational angle of the gripping portion, and a second angle adjusting unit which is installed on the support portion and transmits a rotational force to the rotation portion to adjust a rotational angle of the rotation portion.

The support portion may include a support member which is axially coupled to the rotation portion to rotatably support the rotation portion; a lifting member which is installed on the frame portion to be lifted up and down; and a coupling member connecting the support member and the lifting member.

The rotation portion may include a bracket which forms an accommodation space capable of accommodating the gripping portion and the first angle adjusting unit therein and is rotatably coupled to the support member to be rotatable clockwise or counterclockwise on one surface of the support member when the second angle adjusting unit is driven; a driven gear provided between the bracket and the support member; a gear fixing member protruding outward from the bracket to fix the driven gear to the outer surface of the bracket; and a diaphragm provided on an inner surface of the bracket to divide a space in the bracket into a plurality of spaces.

The gripping portion may include a first support arm rotatably installed on one side of the bracket and a second support arm rotatably installed on the other side of the bracket and disposed opposite to the first support arm, and the first support arm and the second support arm may include a rotational shaft portion rotatably installed on the bracket and disposed in an inner space of the bracket; and a gripping body which is coupled with the rotational shaft portion to be disposed in an outer space of the bracket and separated outwardly or retracted inwardly by rotating together with the rotational shaft portion according to the driving of the first angle adjusting unit.

The first angle adjusting unit may include a first arm controller which is installed inside the bracket to rotate the first support arm and a second arm controller which is installed inside the bracket and disposed opposite to the first arm controller to rotate the second support arm, and the second angle adjusting unit may be installed on the support member and transmits the rotational force to the driven gear to rotate the bracket.

The first arm controller and the second arm controller may include a first power transmission gear which is installed around the rotational shaft portion to be rotatable together with the rotational shaft portion; a second power transmission gear which is rotatably installed inside the bracket and transmits the rotational force to the first power transmission gear to rotate the first power transmission gear; and a first driving device which is installed inside the bracket to be connected with the second power transmission gear and performs linear motion to rotate the second power transmission gear clockwise or counterclockwise.

The first driving device may include a linear actuator which is installed inside the bracket and performs linear motion in a longitudinal direction of the bracket; and a third power transmission gear which is installed on the linear actuator to be gear-engaged with the second power transmission gear and linearly moves to one side or the other side when the linear actuator is driven to rotate the second power transmission gear.

### Effect

According to the embodiment of the present invention, since the operator can automatically load the cargo by controlling the cargo loading unit without manually loading the cargo, the hand lift device can operate faster than manual operation, load more cargo over the same time, and operate with a small number of persons, thereby reducing the cost.

Further, the proximity sensor for sensing the height of the cargo loaded on the cargo loading unit is provided and the loaded cargo is maintained at a predetermined height through the driving of the automatic operation mode, so that the operator can load or unload the cargo without bending the back, thereby solving the problem of chronic back pain of the operators who perform the simple repetition of the unloading operation and improving the operation efficiency of the operator.

Further, a means for applying a tension to the chain for lifting the cargo loading unit is provided to adjust the tension of the chain even when high-weight loaded cargo is loaded on the cargo loading unit, thereby increasing loading stability.

Further, the cargo loading unit is configured to be attached or detached and the attaching or detaching method is simply configured to deviate from an inconvenient attaching or detaching method such as a screw coupling method in the related art, thereby efficiently improving convenience of the operator.

Further, a gripping blade which is pressed against the outer surface of the cargo when the cargo is loaded on the cargo loading unit to be separated outwardly and then automatically retracted inwardly by an elastic force to support the outer surface of the cargo is provided, so that the operator can automatically load the cargo only by an operation of sliding the gripping blade to the outer surface of the cargo through the movement of the hand lift device without loading the cargo manually, thereby shortening significantly a cargo loading time and improving workability.

Further, when the cargo loading unit is lifted up through the hand lift device, the load acting on the cargo in the vertical direction is added to the gripping blade that supports the stepped portion of the cargo, and thus the gripping blade is further retracted inwardly toward the outer surface of the cargo, thereby strengthening the supporting force acting on the cargo and more stably fixing the cargo.

Further, the cargo loading unit includes a tongs-shaped gripping portion capable of gripping the cargo by adjusting the accommodation space through the relative motion, thereby easily gripping and loading the cargo having various sizes and shapes.

Further, since the cargo loading unit is provided with the rotation portion which is rotatable clockwise or counterclockwise, the cargo can be gripped at various positions, thereby increasing the usability and efficiently loading various types of cargo.

Further, the cargo loading unit includes the driving portion to which the linear actuator is applied to control the gripping portion, and thus the pressing force suitable for the cargo is finely adjusted according to the shape of the cargo, the material of the cargo or the hardness of the cargo, thereby stably loading the cargo.

Further, the loaded cargo can move in front, rear, left, right, upper and lower directions by the cargo loading unit and the moving support portion, thereby stably carrying and unloading the loaded cargo at various positions.

### DESCRIPTION OF DRAWINGS

FIG. 1 is a perspective view illustrating a hand lift device according to an embodiment of the present invention.

FIG. 2 is a schematic side view illustrating the hand lift device according to the embodiment of the present invention.

FIG. 3 is a side view schematically illustrating an internal structure of the hand lift device according to the embodiment of the present invention.

FIG. 4 is an enlarged perspective view illustrating one section of the hand lift device according to the embodiment of the present invention.

FIG. 5 is an exploded perspective view illustrating a state in which a moving support portion is separated from a frame portion of the hand lift device according to the embodiment of the present invention.

FIG. 6 is a side view illustrating a state in which a fixing support portion is installed on the frame portion of the hand lift device according to the embodiment of the present invention.

FIG. 7 is a side view schematically illustrating a state in which a boarding portion is installed on the hand lift device according to the embodiment of the present invention.

FIG. 8 is a perspective view illustrating a hand lift device according to another embodiment of the present invention.

FIG. 9 is a side view schematically illustrating the hand lift device according to another embodiment of the present invention.

FIG. 10 is a side view schematically illustrating a driving method of the hand lift device according to another embodiment of the present invention.

FIG. 11 is a perspective view illustrating a part of the hand lift device according to another embodiment of the present invention to which a cargo loading unit is applied.

FIG. 12 is a perspective view illustrating a hand lift device according to yet another embodiment of the present invention to which a cargo loading unit is applied.

FIG. 13 is a perspective view illustrating the cargo loading unit illustrated in FIG. 12.

FIG. 14 is a cross-sectional view schematically illustrating a state in which a first blade is installed on a first arm of the cargo loading unit according to yet another embodiment of the present invention.

FIG. 15 is a plan view schematically illustrating a state in which a first arm and a second arm are installed on a horizontal member of the cargo loading unit according to yet another embodiment of the present invention.

FIG. 16 is a view schematically illustrating a state in which a first blade is installed on a first arm by a grip space adjusting unit in the cargo loading unit according to yet another embodiment of the present invention.

FIG. 17 is a plan view schematically illustrating a state in which cargo is not loaded on the cargo loading unit according to yet another embodiment of the present invention.

FIG. 18 is a view schematically illustrating a process in which cargo is loaded on the cargo loading unit according to yet another embodiment of the present invention.

FIG. 19 is a view schematically illustrating a state in which a guide roller is installed on a blade body of the cargo loading unit according to yet another embodiment of the present invention.

FIG. 20 is a perspective view illustrating a hand lift device according to still another embodiment of the present invention to which a cargo loading unit is applied.

FIG. 21 is a view schematically illustrating the cargo loading unit illustrated in FIG. 20.

FIG. 22 is a view schematically illustrating a modified example of the cargo loading unit according to still another embodiment of the present invention.

FIG. 23 is a view schematically illustrating another modified example of the cargo loading unit according to still another embodiment of the present invention.

FIG. 24 is a view schematically illustrating a first angle adjusting unit of the cargo loading unit of FIG. 23.

FIG. 25 is a view schematically illustrating another form of a chain tensioner.

### BEST MODE

Hereinafter, various embodiments will be described in detail with reference to the accompanying drawings. The embodiments described in this specification may be variously modified. Specific embodiments are described in the drawings and may be described in detail in the detailed description. It should be understood, however, that the specific embodiments disclosed in the accompanying drawings are intended only to facilitate understanding of various embodiments. Accordingly, it is to be understood that the technical idea is not limited by the specific embodiments disclosed in the accompanying drawings, but includes all equivalents or alternatives included within the spirit and scope of the invention.

Terms including an ordinary number, such as first and second, are used for describing various constituent elements, but the constituent elements are not limited by the terms. The above terminologies are used only to discriminate one component from the other component.

In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations, in advance. It should be understood that, when it is described that an element is “coupled” or “connected” to another element, the element may be “directly coupled” or “directly connected” to the another element or “coupled” or “connected” to the another element through a third element. In contrast, it should be understood that, when it is described that an element is “directly coupled” or “directly connected” to another element, it is understood that no element is present between the element and the another element.

Meanwhile, the “module” or “portion” for the component used in this specification performs at least one function or operation. In addition, the “module” or “portion” may perform a function or operation by hardware, software, or a combination of hardware and software. Also, a plurality of “modules” or a plurality of “portions” except for the “module” or “portion” performed in specific hardware or performed in at least one processor may be combined into at least one module. A singular form may include a plural form if there is no clearly opposite meaning in the context.

In describing the present disclosure, a detailed explanation of known related technologies may be omitted to avoid unnecessarily obscuring the subject matter of the present disclosure.

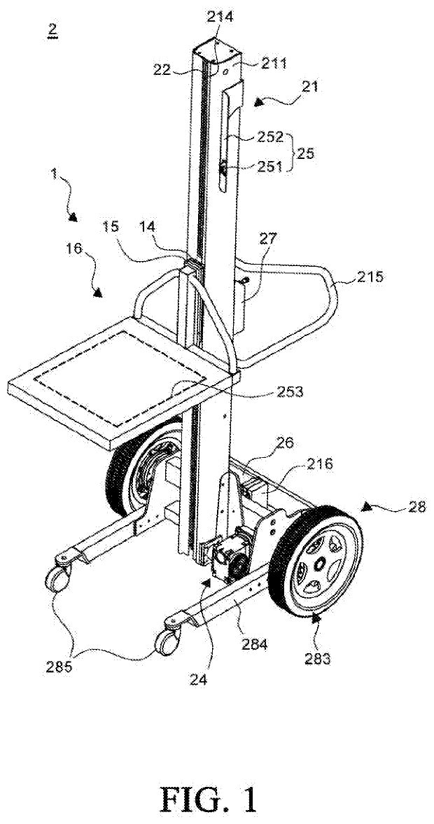

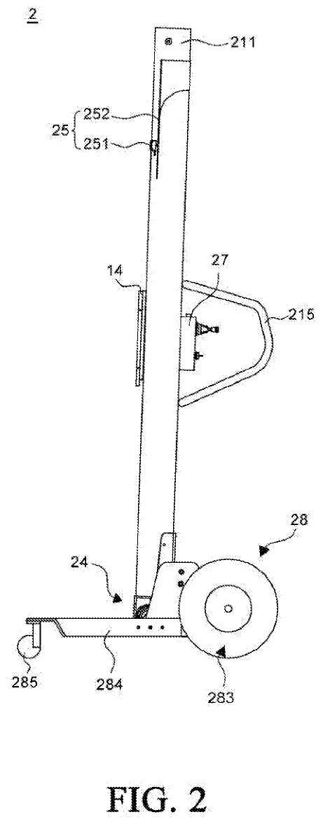

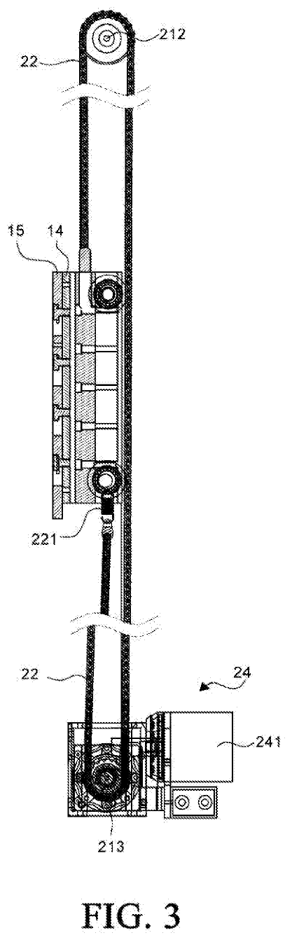

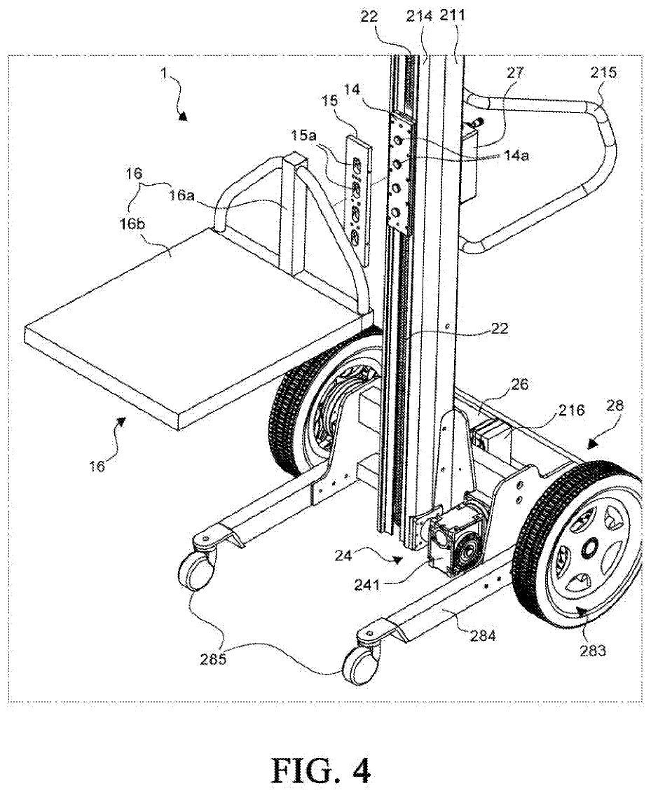

FIG. 1 is a perspective view illustrating a hand lift device according to an embodiment of the present invention, FIG. 2 is a schematic side view illustrating the hand lift device according to the embodiment of the present invention, FIG. 3 is a side view schematically illustrating an internal structure of the hand lift device according to the embodiment of the present invention, and FIG. 4 is an enlarged perspective view illustrating one section of the hand lift device according to the embodiment of the present invention.

Referring to FIGS. 1, 2, and 3, a hand lift device 2 (hereinafter, referred to as the ‘hand lift device 2’) according to the embodiment of the present invention includes a frame portion 21, a chain 22 disposed in a longitudinal direction of the frame portion 21, a cargo loading unit 1 configured to be connected to the chain 22 to load cargo, a power transmission portion 24 providing a driving force to the chain 22, a sensor portion 25 sensing cargo (not illustrated) loaded on the cargo loading unit 1, and a controller 26 controlling driving of the power transmission portion 24 according to a sensing signal from the sensor portion 25.

The frame portion 21 includes a vertical frame 211, a first sprocket 212, and a second sprocket 213.

A guide rail 214 is formed inside the vertical frame 211, the first sprocket 212 is disposed on the upper side of the vertical frame 211, and the second sprocket 213 is disposed on the lower side of the vertical frame 211.

The chain 22 is installed to engage with the first sprocket 212 and the second sprocket 213. The first sprocket 212 and the second sprocket 113 function as pulleys for supporting the chain 22 at the upper and lower ends of the vertical frame 211, respectively. The first sprocket 212 and the second sprocket 213 are preferably installed on the vertical frame 211 so as to be symmetrically positioned at positions facing each other, respectively.

The chain 22 receives the driving force from the power transmission portion 24 to be described below to rotate by engaging with the first sprocket 212 and the second sprocket 213.

The cargo loading unit 1 is configured to be connected to the chain 22 and move up and down along the guide rail 214 connected to the chain 22 and formed in the vertical frame 211. In addition, the cargo loading unit 1 is configured so that the chain 22 is connected to the rear surface of the cargo loading unit 1 and the cargo is loaded on the front side of the cargo loading unit 1.

Referring to FIG. 4, the cargo loading unit 1 may include a loading member 16 on which the cargo is loaded, a lifting member 14 which is connected to the chain 22 to lift up and down along the guide rail 214 formed on the vertical frame 211 when the chain 22 moves, and a coupling member 15 connecting the loading member 16 and the lifting member 14.

The loading member 16 may include a vertical panel 16a coupled to the lifting member 14 by the coupling member 15 and a horizontal panel 16b formed in a flat plate shape to load the cargo. The vertical panel 16a and the horizontal panel 16b may be formed to be substantially at a right angle.

Here, at least one protruding portion 14a is formed on the lifting member 14 and at least one engaging portion 15a formed to engage with the protruding portion 14a is formed on the coupling member 15 so that the protruding portion 14a and the engaging portion 15a may be coupled to each other by a female-male fitting method. Accordingly, unlike a conventional bolt-nut coupling method in which a plurality of structures is connected to each other using a separate fastening tool, the cargo loading unit 1 may be rapidly attached or detached to or from the hand lift device 2 without a separate tool and the cargo loading unit 1 may be firmly fixed to the hand lift device 2. However, the cargo loading unit 1 is not limited to those illustrated in FIGS. 1 and 4, and may be applied in various shapes. This will be described later.

The power transmission portion 24 includes an electric motor 241. The electric motor 241 is preferably a brushless motor, and in addition, as the electric motor 241, various known motors such as a stepping motor and a servo motor may be applied.

Referring to FIG. 3, a drive shaft of the electric motor 241 rotates by engaging with the second sprocket 213 and provides a driving force to the chain 22. The chain 22 is sequentially gear-coupled to the first sprocket 212 and the second sprocket 213 and the driving force generated from the electric motor 241 is transmitted to the chain 22 through the second sprocket 213.

The chain 22 is connected to the lifting member 14 and transmits the driving force from the power transmission portion 24 to the cargo loading unit 1 through the lifting member 14. Specifically, one end of the chain 22 may be connected to the upper end of the lifting member 14, and the other end of the chain 22 may be connected to the lower end of the lifting member 14.

At this time, a chain tensioner 221 to provide tension to the chain may be interposed in at least one of the points where the chain 22 and the lifting member 14 are connected.

The chain tensioner 221 is a spring member having self-elasticity, and both end portions may be formed in an annular shape. The chain tensioner 221 has one end connected to the chain 22 and the other end connected to the lifting member 14 to apply tension to the chain 22 while mediating the connection between the chain 22 and the lifting member 14. The chain tensioner 221 serves to keep the tension of the chain 22 at a predetermined level or more. When a heavy load is applied to the cargo loading unit 1, the chain 22 may temporarily be sagged. At this time, the chain tensioner 221 may compensate for the sagging of the chain 22 using self-elasticity.

Meanwhile, the chain tensioner 221 may be formed in the form of an elastic structure that is coupled to the lifting member 14 and generates a predetermined elastic force to provide the tension to the chain 22.

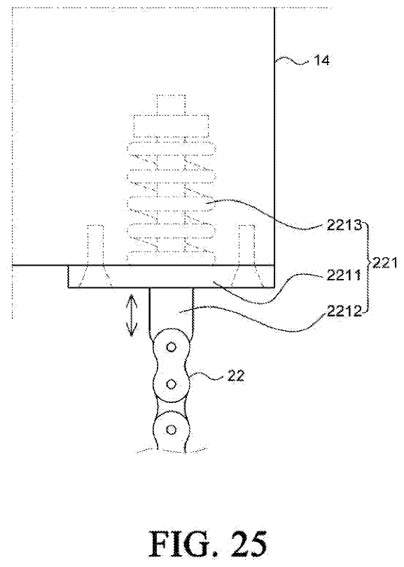

Referring to FIG. 25, the chain tensioner 221 may include a support panel 2211 fastened to the lifting member 14 through a plurality of fastening means, a chain connection portion 2212 of which one side is exposed outside the support panel 2211 through the support panel 2211 to be coupled to the chain 22 and the other side is accommodated inside the lifting member 14, and a spring member 2213 elastically supporting the chain connection portion 2212 while being accommodated inside the lifting member 14, interposed between the chain connection portion 2212 and the support panel 2211, and supported by the support panel 2211. Herein, the chain connection portion 2212 may be formed in a structure having a bolt portion connected to the chain 22 and a nut portion fastened to one side of the bolt portion and elastically supported by the spring member 2213. Accordingly, the tension transmitted to the chain 22 may be adjusted through a process of tightening or loosening the bolt portion to which the chain 22 is connected. In addition, the spring member 2213 is interposed between the chain connection portion 2212 and the support panel 2211 so as to apply a reaction force in an opposite direction while being supported by the support panel 2211 to prevent the spring member from stretching indefinitely and prevent the chain from sagging even when the cargo having a limited weight or more is loaded.

However, the chain tensioner 221 is not necessarily limited thereto, and may be modified into various structures and shapes as long as it can compensate for the sagging of the chain 22.

Therefore, the hand lift device 2 is provided with a means for applying tension to the chains 22 and 32 for lifting up and down the cargo loading unit 1, thereby increasing the loading stability by adjusting the tension of the chain 22 even when the high-weight cargo is loaded on the cargo loading unit 1.

On the other hand, a decelerator (not illustrated) for reducing the rotational force of the electric motor 241 may be further selectively provided between the electric motor 241 and the chain 22. In this case, the rotational force of the electric motor 241 is transmitted to the chain 22 via the decelerator. Further, a worm (not illustrated) and a worm gear (not illustrated) may be included between the driving shaft of the electric motor 241 and the rotating shaft of the second sprocket 213, respectively.

Referring back to FIGS. 1 and 2, the sensor portion 25 senses the cargo loaded on the cargo loading unit 1. Specifically, the sensor portion 25 includes a proximity sensor 251 for sensing the cargo loaded on the cargo loading unit 1 and a sensor support portion 152 for supporting the proximity sensor 251.

The proximity sensor 251 is a sensor for sensing an object when an object (cargo in the present invention) approaches, and various known proximity sensors such as a hall sensor and an optical sensor may be used.

The proximity sensor 251 is guided to move in a longitudinal direction of the vertical frame 211 in the range of both ends of a sensor guide 252. At this time, even if the proximity sensor 251 is located at the lowermost position of the sensor guide 252, it is preferable that the proximity sensor 251 is disposed at an upper side of a range in which the cargo loading unit 1 is lifted up and down. The sensor guide 252 may be configured in the form of a bracket to be detachable at any point of the vertical frame 211. The proximity sensor 251 may move along a slot formed in the sensor guide 252 and may also be fixed by various attachment means such as a magnet.

In addition, the sensor portion 25 may further include a load cell 253.

Referring to FIG. 1, the load cell 253 is installed on the cargo loading unit 1, and may detect the load of the cargo loaded on the cargo loading unit 1 to transmit a signal of the detected load to the controller 26 to be described below.

The controller 26 controls the lifting of the cargo loading unit 1 based on the cargo sensing signal from the sensor portion 25. Accordingly, the hand lift device 2 automatically adjusts the height of the cargo loading unit 1 according to the height of the loaded cargo or the load of the cargo.

Specifically, the controller 26 controls the lifting of the cargo loading unit 1 by controlling the driving of the power transmission portion 24 in accordance with the sensing signal transmitted from the proximity sensor 251 of the sensor portion 25.

That is, the controller 26 controls the driving of the power transmission portion 24 to maintain the height of the upper end of the cargo loaded on the cargo loading unit 1 at a predetermined height, based on the cargo sensing signal from the sensor portion 25.

Specifically, the controller 26 may transmit control commands to each configuration so as to operate in a ‘load mode’ of loading the cargo and an ‘unload mode’ of unloading the cargo.

The ‘load mode’ is an automatic operation mode when the operator loads the cargo on the cargo loading unit 1. When a plurality of cargo is loaded, an operator typically loads one cargo and loads the next cargo on top of the cargo. In order to load the next cargo, the operator loads the next cargo by a height higher than the previously loaded cargo. At this time, a large load is applied to the back of the operator.

Therefore, in order to allow the operator to constantly maintain the height at which the cargo is lifted when the operator loads a plurality of cargo, the hand lift device 2 controls the driving of the power transmission portion 24 so that the cargo loading unit 1 is lifted down by the height of the previously loaded cargo. At this time, the controller 26 maintains the driving the power transmission portion 24 when the cargo sensing signal is received from the sensor portion 25, and stops the driving the power transmission portion 24 when the receiving of the cargo sensing signal from the sensor unit 25 is stopped.

The ‘unload mode’ is an automatic operation mode when the operator unloads the cargo from the cargo loading unit 1. When the plurality of cargo is unloaded, generally, the operator unloads one cargo and then unloads the next cargo below the cargo thereof. In order to unload the next cargo, the operator unloads the next cargo by bending the back at a height lower than the previously unloaded cargo. At this time, a large load is applied to the back of the operator.

Therefore, in order to allow the operator to constantly maintain the height at which the cargo is lifted when the operator unloads the plurality of cargo, the hand lift device 2 controls the driving of the power transmission portion 24 so that the cargo loading unit 1 is lifted up by the height of the previously unloaded cargo. At this time, the controller 26 maintains the driving the power transmission portion 24 when the cargo sensing signal is not received from the sensor portion 25, and stops the driving the power transmission portion 24 when the cargo sensing signal is received from the sensor unit 25.

That is, the hand lift device 2 is provided with the proximity sensor 251 for sensing the height of the cargo loaded on the cargo loading unit 1 and allows the loaded cargo to be maintained at a predetermined height through the driving of the above-described automatic operation mode (load mode or unload mode), thereby loading or unloading the cargo without bending the back of the operator. Thus, the hand lift device 2 may not only solve the problem of the chronic back pain of the operators who perform the conventional simple repetition of loading and unloading but also significantly contribute to the operation efficiency of the operators.

Further, the controller 26 controls the lifting of the cargo loading unit 1 by controlling the driving of the power transmission portion 24 in accordance with the sensing signal transmitted from the load cell 253 of the sensor portion 25.

That is, according to the selected drive mode, the controller 26 compares the cargo sensing signal transmitted from the sensor portion 25, that is, the signal relating to the load of the cargo loaded on the cargo loading unit 1, with a predetermined reference signal to control the driving of the power transmission portion 24 and maintain the height of the upper end of the cargo loaded on the cargo loading unit 1 at a predetermined height.

Specifically, in the ‘load mode’ in which the power transmission unit 24 is driven so that the cargo loading unit 1 is lifted down, the controller 26 compares the cargo sensing signal received from the sensor portion 25 with a preset first reference signal in real time and maintains the driving of the power transmission portion 24 until the cargo sensing signal reaches the first reference signal. Here, the first reference signal may be set to a signal corresponding to the total load of the cargo to be loaded.

On the contrary, in the ‘unload mode’ in which the power transmission unit 24 is driven so that the cargo loading unit 1 is lifted up, the controller 26 compares the cargo sensing signal received from the sensor portion 25 with a preset second reference signal in real time and maintains the driving of the power transmission portion 24 until the cargo sensing signal reaches the second reference signal. Here, the second reference signal may be set to a signal corresponding to a value of zero.

In addition, the hand lift device 2 may include a control portion 27 configured to allow an operator to control the operation of the hand lift device 2.

The control portion 27 includes a power supply switch capable of turning on/off the operating power of the electric motor 241, a joystick capable of lifting up the cargo loading unit 1 to an arbitrary position, a manual operation switch for setting the hand lift device 2 to operate in a manual mode, an automatic operation switch for automatically setting the power transmission portion 24 to be controlled based on the sensing signal from the sensor portion 25, and the like. However, the control portion 27 is not limited thereto, and may further include various control means for controlling the hand lift device 2.

In addition, the hand lift device 2 includes a battery 216 for supplying power. The battery 216 may be accommodated below the hand lift device 2 together with the controller 26.

Further, the hand lift device 2 of the present invention may further include a moving support portion 28.

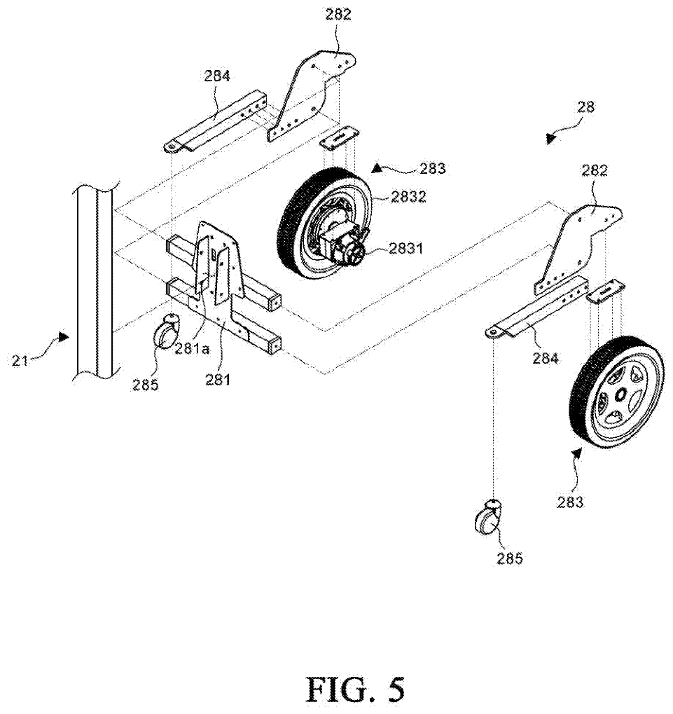

FIG. 5 is an exploded perspective view illustrating a state in which the moving support portion 28 is separated from the frame portion 21 of the hand lift device 2 according to the embodiment of the present invention.

Referring to FIGS. 1 and 5, the moving support portion 28 is detachably mounted on the frame portion 21 to support the frame portion 21 and move the frame portion 21 to a predetermined position.

The moving support portion 28 may include a frame support structure 281, a pair of support panels 282, a pair of wheels 283, and a pair of forks 284.

The frame support structure 281 has a slot 281a which can accommodate a part of the frame portion 21 therein to support the outer surface of the frame portion 21 accommodated in the slot 281a and may be detachably coupled to the frame portion 21. For example, the frame support structure 281 may be detachably coupled to the frame portion 21 using a separate fastening means such as bolts and nuts.

The pair of support panels 282 is coupled to both ends of the frame support structure 281 in a longitudinal direction of the frame support structure 281, respectively, and is coupled to the pair of wheels 283 and the pair of forks 284 to be described below to support the pair of wheels 283 and the pair of forks 284. For example, the pair of support panels 282 may be coupled to both ends of the frame support structure 281 using a separate fastening means such as bolts and nuts, respectively, and the pair of support panels 282 may have a plurality of fastening holes for fastening.

Further, the pair of support panels 282 may be formed of a non-ferrous metal material.

More specifically, the pair of support panels 282 may be formed of a magnesium material having a predetermined thickness. However, the pair of support panels 282 is not necessarily limited to the material thereof, and may be formed of aluminum or a magnesium alloy which contains magnesium as a main component, if necessary.

The pair of wheels 283 is coupled to the support panels 282 and is arranged behind the frame portion 21 and performs rotational motion in a state of being grounded on the ground surface so that the frame portion 21 loaded with the cargo may move to a predetermined position.

Here, the pair of wheels 283 may be formed as a motor-integrated structure capable of generating power by itself to perform rotational motion.

More specifically, the pair of wheels 283 may include a wheel motor 2831 which is coupled to and supported to the support panels 282 and generates a rotational force, and a wheel body 2832 which is rotatably coupled to the wheel motor 2831 and performs rotational motion through the rotational force transmitted from the wheel motor 2831. For example, the wheel motor 2831 is connected to a battery 216 to receive power, and is electrically connected to the controller 26 and the control portion 27 to control a rotational direction, a rotational speed, and the like through the operation of the control portion 27.

Therefore, the hand lift device 2 can be moved to front, rear, left, right, upper and lower sides through the cargo loading unit 1 and the moving support portion 28, so that the loaded cargo may be stably carried and unloaded to various positions.

The pair of forks 284 may be coupled to the support panel 282 and disposed in front of the frame portion 21 and may have a caster 285 at the end to switch the movement direction of the frame portion 21.

Therefore, when the height of the cargo loaded on the hand lift device 2 is large, the operator may load the cargo directly onto the forks 284 by separating the cargo loading unit 1 from the frame portion 21, and may also easily switch the movement position in a desired direction through the caster 285 when the hand lift device 2 is moved. For example, the caster 285 may be formed in the form of a wheel that is rotatably coupled to a pair of forks 284 on the ground and performs rotational motion along the ground.

Further, the pair of forks 284 can be positioned in the front and rear direction of the frame portion 21 along the surface of the support panel 282.

Accordingly, the operator may adjust the length of the fork 284 according to the weight and the size of the cargo to be loaded, thereby stably distributing the load acting on the frame portion 21.

For example, a plurality of fastening holes may be formed in a longitudinal direction of the support panel 282, and fastening holes corresponding to at least one of the plurality of fastening holes may be formed in the pair of forks 284. Accordingly, the pair of forks 284 may be disposed at a position corresponding to any of the plurality of fastening holes described above, and then fixed to the support panel 282 through a separate fastening means such as bolts and nuts.

Meanwhile, referring to FIGS. 1 and 2, the hand lift device 2 may further include a handle bar 215.

The handle bar 215 is provided on the rear surface of the frame portion 21 and can adjust a position in the longitudinal direction of the frame portion 21 and can also adjust a height while being fixed to any one position of the frame portion 21.

Accordingly, the operator can stably grip the handle bar 215 at various positions, and can also steer the hand lift device 2 using the handle bar 215 in a state in which the pair of wheels 283 is driven.

Further, although not illustrated in the drawings, the handle bar 215 may further include an auxiliary control means (not illustrated) capable of controlling the hand lift device 2. Thus, the user may easily operate the hand lift device 2 while gripping the handle bar 215.

Further, the hand lift device 2 may further include a fixing support portion 29.

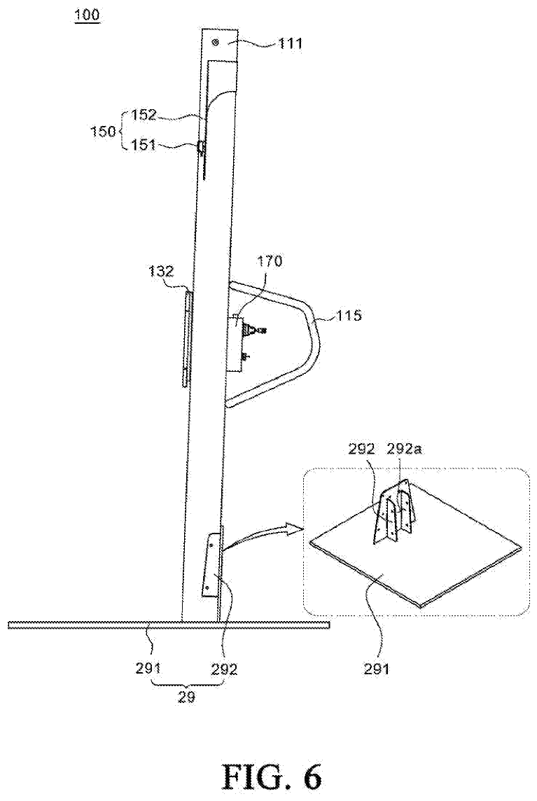

FIG. 6 is a side view illustrating a state in which the fixing support portion 29 is installed on the frame portion 21 of the hand lift device 2 according to the embodiment of the present invention.

Referring to FIG. 6, the fixing support portion 29 is detachably mounted on the frame portion 21, and may be supported on the ground to support the frame portion 21 in a direction perpendicular to the ground.

The fixing support portion 29 may include a fixing panel 291 and a vertical support frame 292.

The fixing panel 291 is formed in a flat plate and installed on the ground so as to support the vertical support frame 292 to be described below and distribute the load acting in the vertical direction from the vertical support frame 292 to the ground.

The vertical support frame 292 protrudes upward by a predetermined length in the vertical direction from the upper surface of the fixing panel 291 to form a slot 292a capable of accommodating a part of the frame portion 21 therein and support the outer surface of the frame portion 21 accommodated in the slot 292a. Here, the vertical support frame 292 may be configured to simultaneously support both side surfaces and the rear surface of the frame portion 21 accommodated in the slot 292a.

Further, the hand lift device 2 may further include a boarding portion 40.

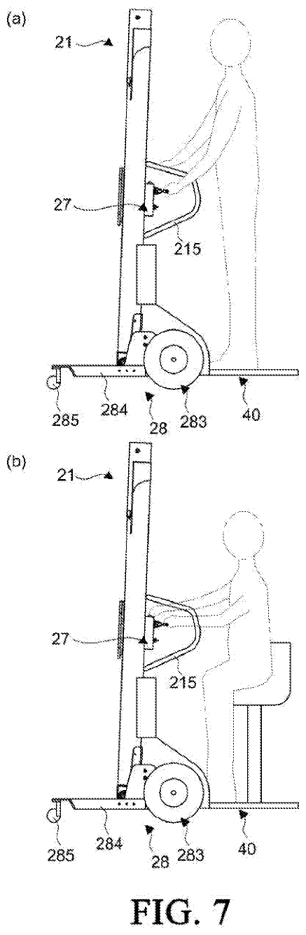

FIG. 7 is a side view schematically illustrating a state in which the boarding portion 40 is installed on the hand lift device 2.

Referring to FIG. 7, the boarding portion 40 may be installed at a rear portion of the frame portion 21, and may be formed in a boardable structure while the user is standing or sitting.

For example, the boarding portion 40 may be formed in a boardable foothold while the user is standing as illustrated in FIG. 7A, and may be formed in a boardable chair while the user is sitting as illustrated in FIG. 7B. In addition, in order to prevent the hand lift device 2 from tilting toward the rear side during boarding of the user, a separate caster (not illustrated) may be further provided at the lower side of the boarding portion 40 to be supported on the ground to distribute the load acting to the boarding portion 40 to the ground. However, the boarding portion 40 is not necessarily limited thereto, and may be modified and applied to various structures and forms.

As described above, since the hand lift device 2 can allow the operator to automatically load the cargo by the cargo loading unit 1 without manually loading the cargo, the hand lift device 2 can operate faster than manual operation, load more cargo over the same time, and operate with a small number of persons, thereby reducing the cost.

Hereinafter, a hand lift device 3 according to another embodiment of the present invention will be described.

For reference, each configuration for describing the hand lift device 3 according to another embodiment of the present invention uses the same reference numeral used for describing the hand lift device 2 for convenience of description, and the same or duplicated description will be omitted.

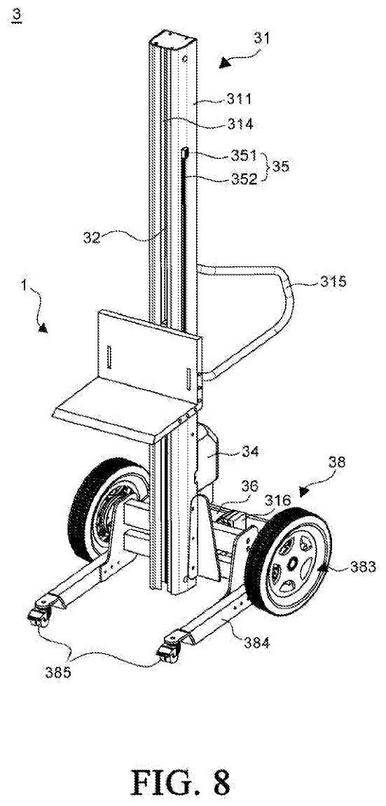

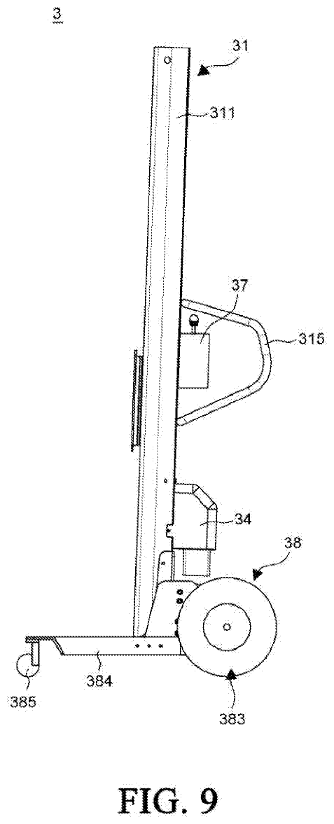

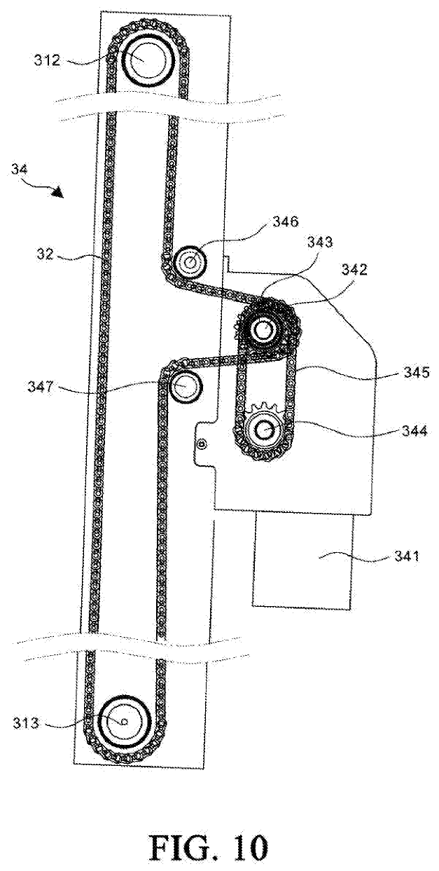

FIG. 8 is a perspective view illustrating a hand lift device 3 according to another embodiment of the present invention, FIG. 9 is a side view schematically illustrating the hand lift device 3 according to another embodiment of the present invention, and FIG. 10 is a side view schematically illustrating a driving method of the hand lift device 3 according to another embodiment of the present invention.

Referring to FIGS. 8 and 9, a hand lift device 3 according to another embodiment of the present invention includes a frame portion 31, a chain 32 disposed in a longitudinal direction of the frame portion 31, a cargo loading unit 1 configured to be connected to the chain 32 to load cargo, a power transmission portion 34 providing a driving force to the chain 32, a sensor portion 35 sensing cargo loaded on the cargo loading unit 1, and a controller 36 controlling driving of the power transmission portion 34 according to a sensing signal from the sensor portion 35.

Referring to FIG. 10, the power transmission portion 34 includes an electric motor 341, a rotational shaft 342 engaging with a driving shaft of the electric motor 341, and a third sprocket 343 connected to the rotational shaft 342.

The chain 32 may be sequentially gear-coupled to a first sprocket 312, a third sprocket 343, and a second sprocket 313. Accordingly, when a driving force is generated from the electric motor 341, the driving force is transmitted to the chain 32 through the third sprocket 343.

The third sprocket 343 is disposed between the first sprocket 312 and the second sprocket 313 and disposed to deviate from a straight path formed by the first sprocket 312 and the second sprocket 313. For example, the chain 32 connecting the first sprocket 312, the third sprocket 343 and the second sprocket 313 is disposed in the shape of a “C” in the vicinity of the third sprocket 343.

The power transmission portion 34 further includes a fourth sprocket 344 and a reinforcement chain 345.

The fourth sprocket 344 is disposed to deviate from a straight path formed by the first sprocket 312 and the second sprocket 313. Further, the fourth sprocket 344 is spaced apart from the third sprocket 343.

At this time, the reinforcement chain 345 is installed to surround the third sprocket 343 and the fourth sprocket 344, and is gear-coupled to the third sprocket 343 and the fourth sprocket 344. The reinforcement chain 345 is disposed to face the chain 32 and the third sprocket 343 in different directions and the chain 32 and the reinforcement chain 345 rotate forward and backward by the driving force of the electric motor 341 transmitted through the third sprocket 343.

The fourth sprocket 344 and the reinforcement chain 345 may complement the driving stability while the chain 32 receives the driving force by the third sprocket 343. Specifically, the third sprocket 343 serves as a shaft, and the fourth sprocket 344, which is a separate shaft, is added to the power transmission portion 34 in which the chain 32 rotates, thereby preventing the chain 32 from sliding in a direction opposite to the rotation direction from the third sprocket 343.

Meanwhile, the power transmission portion 34 may further include a fifth sprocket 346 and a sixth sprocket 347.

The fifth sprocket 346 may be disposed at an arbitrary point between the first sprocket 312 and the third sprocket 343 and the sixth sprocket 347 may be disposed at an arbitrary point between the third sprocket 343 and the second sprocket 313. At this time, the fifth sprocket 346 and the sixth sprocket 347 may press the chain 32 in the direction in which the chain 32 surrounds the third sprocket 343.

The fifth sprocket 346 and the sixth sprocket 347 provide a path through which the chain 32 moves and may add additional tension to the chain 32 to prevent the chain 32 from loosening. That is, the fifth sprocket 346 and the sixth sprocket 347 function to hold the tension of the chain 32 at a predetermined level or more.

Meanwhile, although not illustrated in the drawing, the hand lift device 3 according to another embodiment of the present invention may further include a chain tensioner (not illustrated) separately provided. The chain tensioner may compensate the sagging of the chain 32 by using self-elasticity.

The chain tensioner may be, for example, in the form of a spring member or a structure capable of generating an elastic force of which both ends are connected to the fifth sprocket 346 and the sixth sprocket 347. The spring member may press the chain 32 using the self-elastic force generated between the fifth sprocket 346 and the sixth sprocket 347.

Hereinafter, various embodiments of a cargo loading unit 1 applied to a hand lift device 3 will be described.

For reference, each configuration for describing the cargo loading unit 1 applied to the hand lift device 3 uses the same reference numerals used for describing the hand lift device 2 for convenience of description, and the same or duplicated description will be omitted.

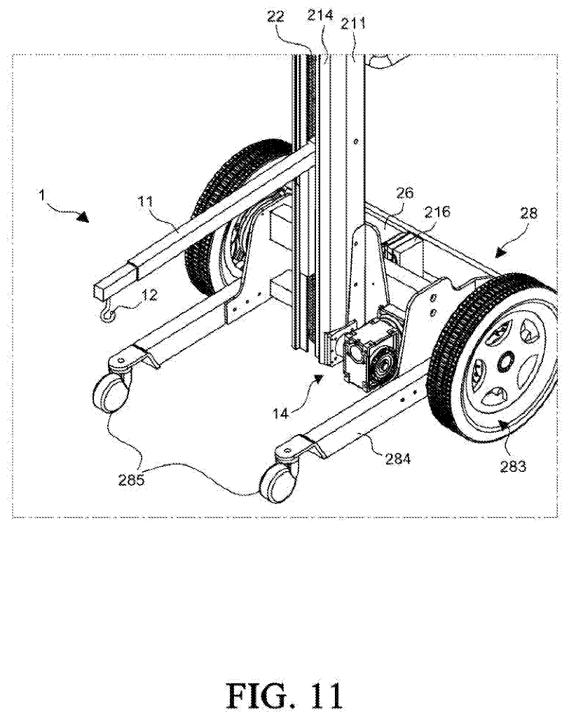

FIG. 11 is a perspective view illustrating a part of the hand lift device according to another embodiment to which a cargo loading unit is applied.

Referring to FIG. 11, the cargo loading unit 1 may include an extension portion 11 and a hook portion 12 positioned at the end of the extension portion 11.

That is, the cargo loading unit 1 may be formed in such a manner that a part of the cargo is hooked on the hook portion 12 to lift the cargo.

In addition, the cargo loading unit 1 may be formed in a shape capable of supporting the edge of the cargo through a plurality of rotatable blades.

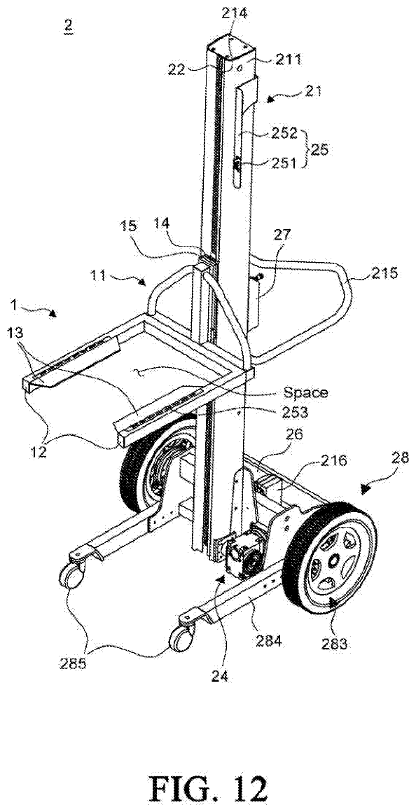

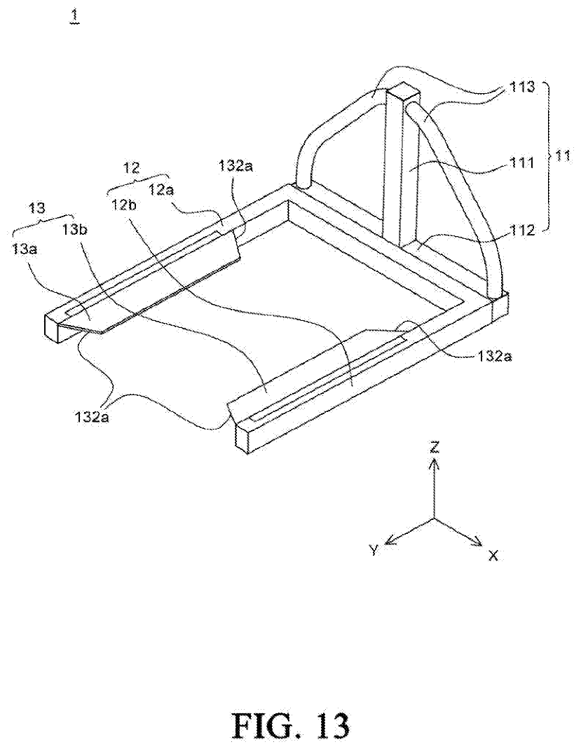

FIG. 12 is a perspective view illustrating a hand lift device according to yet another embodiment to which a cargo loading unit is applied and FIG. 13 is a perspective view illustrating the cargo loading unit illustrated in FIG. 12.

Referring to FIGS. 12 and 13, the cargo loading unit 1 may include a support frame 11.

The support frame 11 may be mounted on the hand lift device 2 and can be lifted up and down through the hand lift device 2 and may be formed in the form of a plurality of structures.

More specifically, the support frame 11 may include a vertical member 111 provided on the hand lift device 2, a horizontal member 112 which is horizontally arranged on the lower side of the vertical member 111 and connected to a support arm 12 to be described below to support the support arm 12, and a reinforcement member 113 for connecting the vertical member 111 and the horizontal member 112.

Further, the cargo loading unit 1 may include the support arm 12.

The support arm 12 protrudes from the end of the support frame 11 in a predetermined length toward the forward direction of the hand lift device 2 and may form an accommodation space capable of accommodating the cargo therein. The support arms 12 may be disposed opposite to each other in the longitudinal direction of the support frame 11, that is, the longitudinal direction of the horizontal member 112.

More specifically, the support arm 12 may include a first arm 12a disposed on one side of the horizontal member 112 in the longitudinal direction of the horizontal member 112, and a second arm 12b disposed on the other side of the horizontal member 112 in the longitudinal direction of the horizontal member 112.

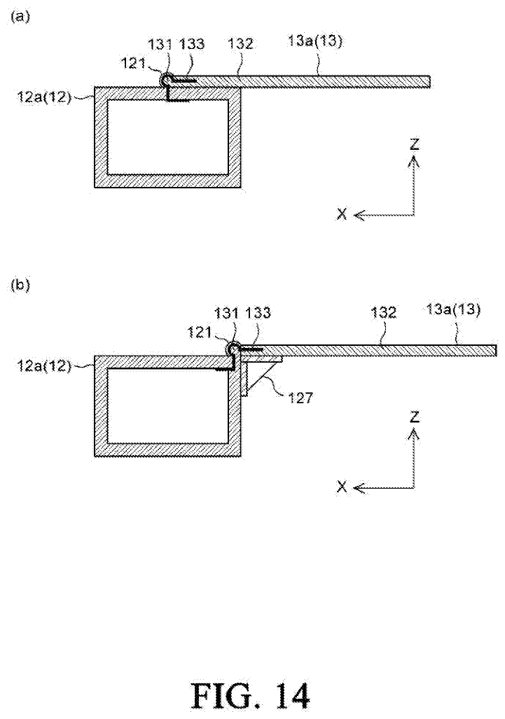

FIG. 14 is a cross-sectional view schematically illustrating a state in which a first blade is installed on a first arm of the cargo loading unit according to yet another embodiment.

Referring to FIG. 14A, the first arm 12a and the second arm 12b may have a hollow tubular structure. A support structure 121 may be formed on the upper surfaces of the first arm 12a and the second arm 12b to have a shaft portion 131 and an elastic member 133 of a gripping blade 13 to be described below. For example, the support structure 121 is formed in a tunnel structure penetrating the inside thereof and may be formed on the middle or end portion in a width direction (X-axis direction) of each of the arms 12a and 12b on the upper surface of each of the arms 12a and 12b. Here, referring to FIG. 14B, when the support structure 121 is formed on the end portion of each of the arms 12a and 12b, a support piece 127 supporting the lower surface of the gripping blade 13 may be further included on the side surface of each of the arms 12a and 12b opposed to each other.

Further, the first arm 12a and the second arm 12b are coupled to the horizontal member 112 in a detachable structure and can relatively move in the longitudinal direction of the horizontal member 112.

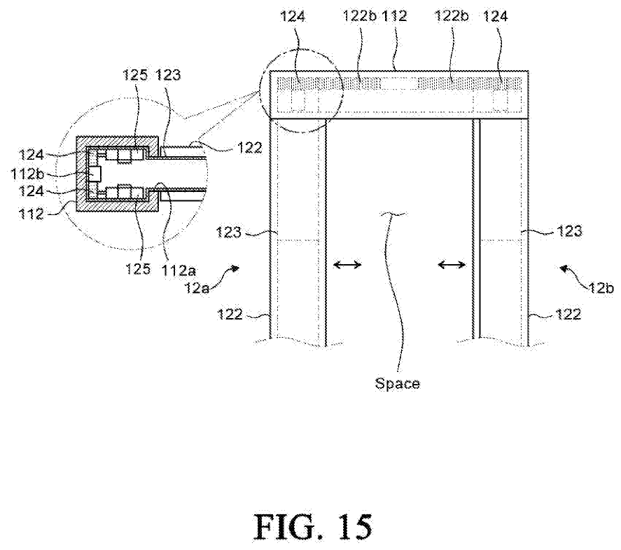

FIG. 15 is a plan view schematically illustrating a state in which the first arm and the second arm are installed on the horizontal member of the cargo loading unit according to yet another embodiment.

Referring to FIGS. 14 and 15, the first arm 12a and the second arm 12b may include a first structure 122 and a second structure 123.

The first structure 122 is disposed on the outer side of the horizontal member 112 and is exposed in the outer space and may have a support structure 121 on one side of which the gripping blade 13 and the elastic member 133 are installed.

The second structure 123 is inserted into the first structure 122 to support the load of the first structure 122 and a part of the second structure 123 is accommodated in the inner space of the horizontal member 112, and when a driving device 125 of the first arm 12a and the second arm 12b is driven, the second structure 123 can be moved along a guide groove 112a. For example, the length of a part of the second structure 123 that is inserted into the first structure 122 corresponds to the entire length of the first structure 122, or may be formed in a half of the entire length of the first structure 122.

On each end of the first arm 12a and the second arm 12b, a plurality of pinion gears 124 which is opposite to the upper and lower sides of a rack gear 112b to generate a rotational force and movable along the rack gear 112b and a driving device 125 transmitting the rotational force to the plurality of pinion gears 124 may be provided. For example, the driving device 125 of the first arm 12a and the driving device 125 of the second arm 12b may be simultaneously controlled, and generate rotational forces in different directions during driving to enable the relative movement of the first arm 12a and the second arm 12b. However, the driving device 125 is not necessarily limited thereto, and may be modified and applied in various forms within conditions that can realize the relative movement of the first arm 12a and the second arm 12b.

Therefore, when a control command is transmitted to the driving device 125 of the first arm 12a and the driving device 125 of the second arm 12b, the respective driving devices 125 are rotated in different directions and move along the rack gear 112b, and as a result, the first arm 12a and the second arm 12b perform relative movement to adjust the size of the accommodation space.

Here, the horizontal member 112 is formed in a hollow tubular structure, and parts of the first arm 12a and the second arm 12b may be accommodated therein, and one side of the horizontal member 112 may have a guide groove 112a which is in contact with the outer surfaces of the first arm 12a and the second arm 12b in a longitudinal direction to guide the movement of the first arm 12a and the second arm 12b. At the inner side of the horizontal member 112, a rack gear 112b which is gear-engaged with a pinion gear 124 provided on each of the first arm 12a and the second arm 12b to guide the movement of the pinion gear 124 may be provided.

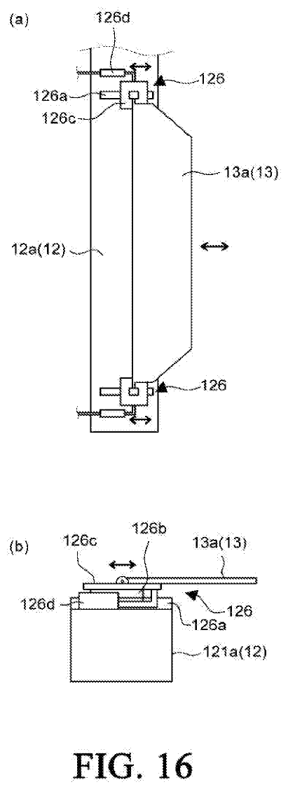

FIG. 16 is a view schematically illustrating a state in which the first blade is installed on the first arm by a grip space adjusting unit in the cargo loading unit according to yet another embodiment.

Referring to FIG. 16, the support arms 12 are installed on the first arm 12a and the second arm 12b to support a first blade 13a and a second blade 13b to be described below, respectively, and may further include a plurality of grip space adjusting units 126 for relatively moving the first blade 13a and the second blade 13b to adjust a distance between the first blade 13a and the second blade 13b.

The grip space adjusting unit 126 may include a guide rail 126a provided on the upper surface of the support arm 12 and a transport block 126b provided on the guide rail 126a and movable along the guide rail 126a. In addition, the grip space adjusting unit 126 may include a support bracket 126c provided on the transport block 126b and rotatably supporting the gripping blade 13. Here, at the center of the upper side of the support bracket 126c, a support structure 121 to which the shaft portion 131 of the gripper blade 13 is rotatably coupled is formed, and the gripping blade 13 which is rotatably coupled to the support structure 121 may be supported on the surface of the support bracket 126c and disposed horizontally when the cargo is unloaded. The gripping space adjusting unit 126 may include a driving device 126d which is provided on the upper surface of the support arm 12 and coupled to the support bracket 126c to move the support bracket 126c. For example, the driving device 126d may be applied to a linearly movable hydraulic device or the like, but is not limited thereto, and may be modified and applied in various forms.

Further, the cargo loading unit 1 may include the gripping blade 13.

Referring to FIGS. 13 and 14, the gripping blade 13 may be rotatably installed on the support arm 12 to be disposed horizontally in the accommodation space.

More specifically, the gripping blade 13 may be supported on the surface of each of the arms 12a and 12b when the cargo is unloaded to be horizontally disposed in the accommodation space, or supported on the surface of the support piece 127 provided on the side surface of each of the arms 12a and 12b to be horizontally disposed in the accommodation space.

Here, the gripping blade 13 may include a first blade 13a rotatably installed on the first arm 12a and a second blade 13b rotatably installed on the second arm 12b.

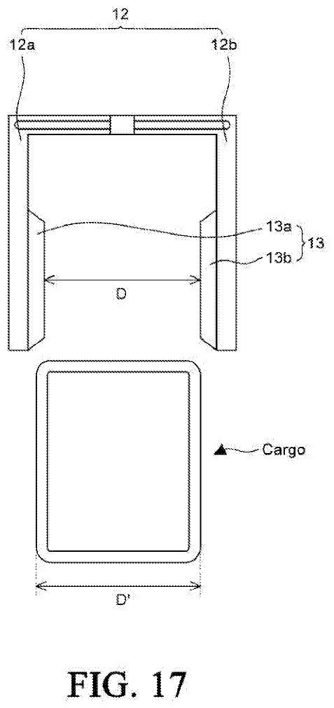

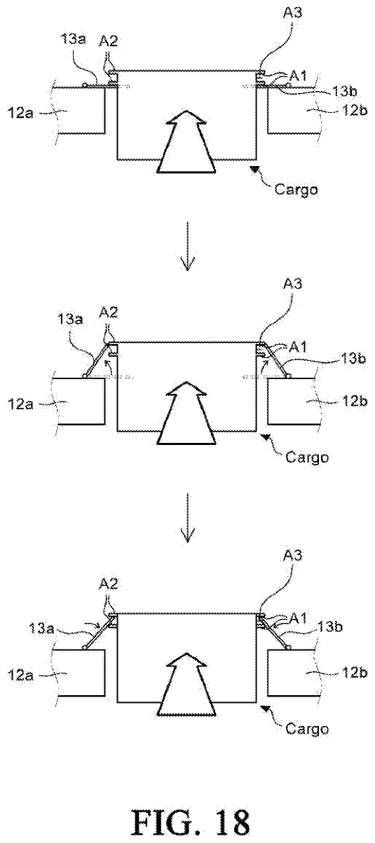

FIG. 17 is a plan view schematically illustrating a state in which cargo is unloaded on the cargo loading unit according to yet another embodiment of the present invention and FIG. 18 is a view schematically illustrating a process in which cargo is loaded on the cargo loading unit according to yet another embodiment of the present invention.

Referring to FIG. 17, when the cargo is unloaded, a distance D between the first blade 12a and the second blade 12b may be smaller than a distance D′ between the first blade 12a and the outer surface of the cargo supported by the second blade 12b.

Referring to FIGS. 13 and 14, the gripping blade 13 may include a shaft portion 131, a blade body 132, and an elastic member 133.

The shaft portion 131 is rotatably coupled to the support structure 121 formed on the upper surface of the support arm 12 and may be formed in the longitudinal direction at one end of the blade body 132.

The blade body 132 extends from the shaft portion 131 to one side to be disposed in the accommodation space and may be rotated clockwise or counterclockwise together with the shaft portion 131 when the shaft portion 131 is rotated. In addition, a plurality of inclined guide surfaces 132a may be formed on one side and the other side of the blade body 132 in the longitudinal direction to guide the movement of the cargo when the cargo is loaded. For example, the plurality of inclined guide surfaces 132a is formed in a structure in which the width of the cross section is gradually narrowed in a direction in which the cargo enters the accommodation space when the cargo is loaded, so that the cargo is not caught by the outer surface of the cargo when the cargo is loaded to be guided to the accommodation space.

The elastic member 133 is provided around the shaft portion 131 to elastically support the blade body 132. Further, the elastic member 133 may restrict a rotational angle of the gripping blade 13. Here, the gripping blade 13 supported by the elastic member 133 may be rotated at an angle between 0° and 90°. For example, the elastic member 133 may act as a return spring which includes a first support wire member supported by the support arm 12, a second support wire member supporting the blade body 132, and a coil-shaped body provided around the shaft portion 131 to connect the first support wire member and the second support wire member.

Accordingly, as illustrated in FIG. 18, the gripping blade 13 rotates at a predetermined angle when the cargo is loaded to be separated outwardly, and then retracts inward by an elastic force to support the outer surface of the cargo.

More specifically, the first blade 13a and the second blade 13b, which are horizontally disposed on the surfaces of the arms 12a and 12b, slid along the outer surface of the cargo through the forward movement of the hand lift device 2, and simultaneously are pressed against the outer surface of the cargo to be separated outwardly. The first blade 13a and the second blade 13b that are separated outwardly are supported on the outer surface of the cargo to maintain in the outwardly separated state and then retracts inward by an elastic force of the elastic member 133 to support the outer surface of the cargo when the cargo reaches a central point between the first blade 13a and the second blade 13b When reaching the center point.

On the other hand, when the cargo loading unit 1 is lifted up by the hand lift device 2, the gripping blade 13 lifts up the cargo by supporting a stepped portion A1 provided on the upper edge of the cargo. At this time, the load acting on the cargo in a vertical direction is added to the gripping blade 13 that supports the stepped portion A1 of the cargo. Accordingly, the gripping blade 13 further retracts inwardly toward the outer surface of the cargo due to the load acting on the cargo in the vertical direction when the cargo is lifted up, and as a result, a support force acting on the cargo is strengthened to further stably fix the cargo.

For reference, the cargo loadable on the cargo loading unit 1 may be formed in a box form which is opened at the top and may accommodate the cargo therein. In addition, on the upper edge of the cargo, a bending portion A2 which protrudes from the outer surface in a predetermined length to form the stepped portion A1 may be formed. Here, a plurality of bending portions A2 may be formed on the outer surface of the cargo to be spaced at predetermined intervals along the height of the cargo, and accommodating grooves A3 which can accommodate a part of the gripping blade 13 may be formed among the plurality of bending portions A2.

Further, the gripping blade 13 may further include a guide roller 134.

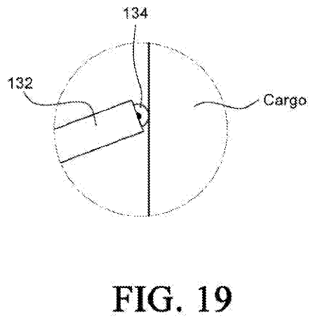

FIG. 19 is a view schematically illustrating a state in which the guide roller is installed on the blade body of the cargo loading unit according to yet another embodiment of the present invention.

Referring to FIG. 19, the guide roller 134 is installed at the end of the blade body 132, and may perform the rotational motion while being in contact with the outer surface of the cargo when the cargo is loaded.

In addition, the hand lift device 2 may further include a plurality of angle adjusting means (not illustrated) which are installed inside the support arm 12 in the longitudinal direction of the support arm 12 and connected with the gripping blade 13 to rotate the gripping blade 13 at a predetermined angle during driving.

For example, the angle adjusting means may include a first gear portion which is installed on the shaft portion 131 of the gripping blade 13 to rotate the shaft portion 131, a second gear portion which is installed inside the support arm 12 to be gear-engaged with the first gear portion and transmits a rotational force to the first gear portion, and a power portion which is installed inside the support arm 12 to be connected to the second gear portion and generates power according to a control command transmitted from the hand lift device 2 to transmit the rotational force to the second gear portion.

Therefore, the hand lift device 2 includes a gripping blade 13, which is pressed against the outer surface of the cargo when the cargo is loaded on the cargo loading unit 1 and separated outwardly and then automatically retract inwardly by an elastic force to support the outer surface of the cargo, so that the operator can automatically load the cargo only by the operation of simply sliding the gripping blade 13 to the outer surface of the cargo through the movement of the hand lift device 2 without manually loading the cargo, thereby significantly shortening a cargo loading time and improving workability.

In addition, when the cargo loading unit 1 is lifted up through the hand lift device 2, the load acting on the cargo in the vertical direction is added to the gripping blade 13 that supports the stepped portion of the cargo. Accordingly, the gripping blade 13 further retracts inwardly toward the outer surface of the cargo, thereby strengthening the supporting force acting on the cargo and more stably fixing the cargo.

In addition, when the cargo is loaded, the gripping blade 13 supports the bottom surface of the cargo and supports the circumferential surface of the cargo accommodated in the accommodation space without lifting up to lower the center of gravity of the loaded cargo, thereby more stably loading the cargo.

Further, the cargo loading unit 1 may be formed in a shape which can grip the outer surface of the cargo through a tongs-shaped gripping means.

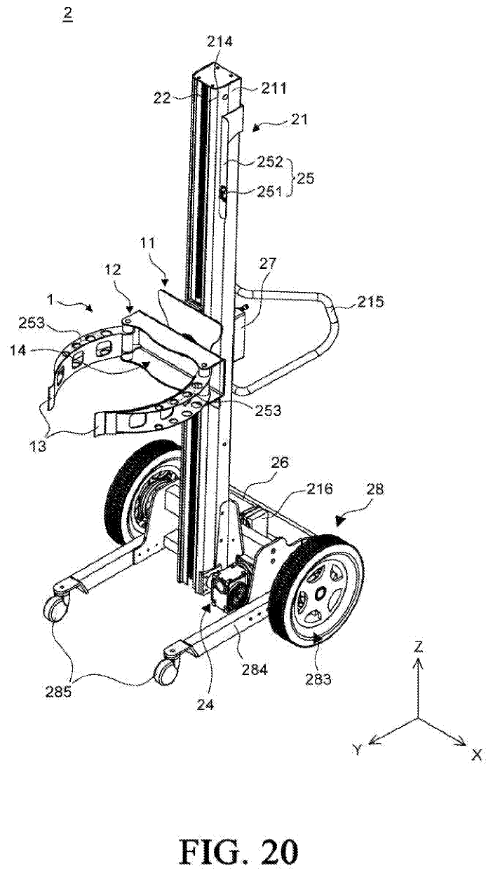

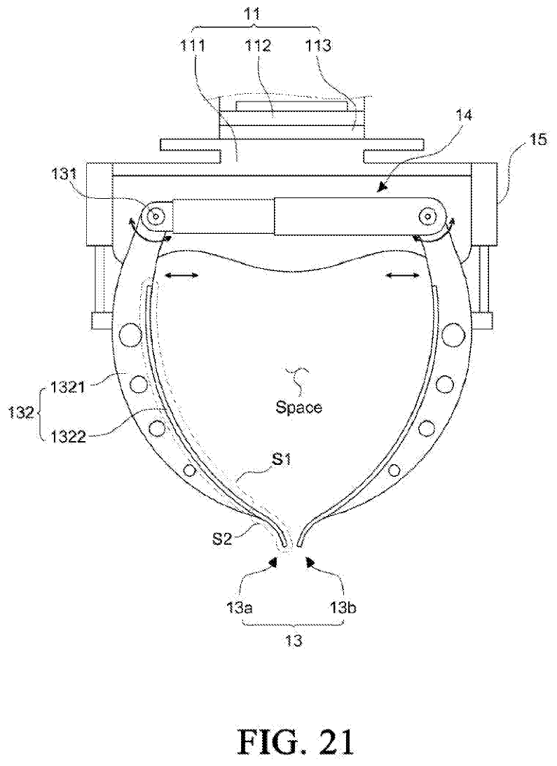

FIG. 20 is a perspective view illustrating a hand lift device according to still another embodiment of the present invention to which a cargo loading unit is applied and FIG. 21 is a plan view schematically illustrating the cargo loading unit illustrated in FIG. 20.

Referring to FIGS. 20 and 21, the cargo loading unit 1 may include a support portion 11.

The support portion 11 may be formed in a plurality of structures that is installed on the hand lift device 2 to be lifted up and down and coupled to each other.

In addition, the support portion 11 may include a support member 111 having a driving portion 14 to be described below installed therein.

More specifically, the support member 111 may be formed in a structure having a ‘C’-shaped cross section to form an accommodation space for accommodating the gripping portion 13 and the driving portion 14 therein. In addition, a support structure may be further formed inside the support member 111 to stably fix the driving portion 14.

Meanwhile, the end portion of the support member 111 facing the accommodation space may be formed to protrude forward by a predetermined length so as to support a part of the cargo when the cargo is placed in the accommodation space.

The support portion 11 may include a lifting member 112 installed on the hand lift device 2 to lift up and down and a coupling member 113 connecting the support member 111 and the lifting member 112. For example, the lifting member 112 and the coupling member 113 may have protrusions and grooves corresponding to each other, and may be coupled by a male-female fitting method at the time of coupling.

Further, the cargo loading unit 1 may include the driving portion 14.

The driving portion 14 is installed on the support portion 11 to be connected with the end portion of the gripping portion 13 accommodated in the support portion 11 and can be extended or contracted by performing linear motion in a horizontal direction. Accordingly, the driving portion 14 may push the gripping portion 13 connected to both ends outward or pull the gripping portion 13 inward to adjust the size of the accommodation space.

More specifically, the driving portion 14 is provided with a monodrum linear actuator that can be extended or contracted by performing the linear motion in the horizontal direction, so that both end portions may be connected to the respective support arms 13a and 13b of the gripping portion 13. The driving unit 14 is extended or contracted by performing the linear motion in the horizontal direction so that the support arms 13a and 13b coupled to both ends thereof relatively move in the horizontal direction, thereby adjusting the size of the accommodating space formed inside the respective support arms 13a and 13b or gripping the outer surface of the cargo accommodated in the accommodation space. However, the driving portion 14 is not necessarily limited to the linear actuator, and may be modified and applied in various configurations within conditions capable of performing the same function.

Further, the cargo loading unit 1 may include the gripping portion 13.

The gripping portion 13 is formed in a tongs shape to be rotatably coupled to both ends of the driving portion 14 and may form an accommodation space capable of accommodating the cargo therein. In addition, the gripping portion 13 may grip the cargo accommodated in the accommodation space by performing the relative motion in a horizontal direction when the driving portion 14 is driven. That is, the gripping portion 13 performs relative movement through the driving portion 14 to adjust the size of the accommodation space according to the size of the cargo to be loaded, then accommodates the cargo in the accommodation space, and presses the outer surface of the cargo accommodated in the accommodation space to grip the cargo. At this time, the gripping portion 13 gripping the cargo may be rotated at a predetermined angle around the coupling point with the driving portion 14 so as to correspond to the outer surface of the gripped cargo.

The gripping portion 13 may include a first support arm 13a which is rotatably installed on one side of the driving portion 14 and a second support arm 13b which is rotatably installed on the other side of the driving portion 14 and disposed opposite to the first support arm 13a to perform the relative movement with respect to the first support arm 13a.

The first support arm 13a and the second support arm 13b may include a rotational shaft portion 131 which is rotatably installed on the end of the driving portion 14 and disposed in the inner space of the support portion 11, and a gripping body 132 which is connected to the rotational shaft portion 131 to grip the cargo.

The gripping body 132 is coupled to the rotational shaft portion 131 so that one side may be disposed in the outer space of the support portion 11 and the other side may be disposed in the inner space of the support portion 11.

In addition, the gripping body 132 may include a rotary blade 1321 and a gripping member 1322.

The rotary blade 1321 may be coupled to the rotational shaft portion 131 to be rotatable together with the rotational shaft portion 131 and may be provided in plural in an axial direction of the rotational shaft portion 131.

The gripping member 1322 is attached to the inner surface of the plurality of rotary blades 1321 and may be in close contact with the outer surface of the cargo to support the cargo when the cargo is loaded.

Here, the gripping member 1322 may be formed with a plurality of gripping surfaces.

More specifically, the gripping member 1322 is provided with a gripping surface S1 which is formed in an arc shape facing the outside in the horizontal direction (X-axis direction) to support the outer surface of the cargo, and a separation prevention surface S2 which is extended from the gripping surface S1 and formed in an arc shape facing the inside in the horizontal direction (X-axis direction) to support the end portion of the cargo. In this case, a space between the plurality of gripping surfaces S1 may be formed to be larger than the space between the plurality of separation prevention surface S2. However, the plurality of gripping surfaces formed on the gripping member 1322 is not necessarily limited thereto, but may be applied to the opposite case, or may be modified and applied into various shapes within conditions capable of performing the same function.

Meanwhile, a plurality of through holes may be formed in the gripping body 132 to reduce the weight of the gripping body 132. On the one surface of the gripping member 1322 that is in contact with the cargo, a material having a large surface resistance may be coated or attached, or a protrusion and the like may be further formed so as to more stably grip the cargo when the cargo is loaded.

Further, the cargo loading unit 1 may further include a cushioning portion 15.

The cushioning portions 15 are provided at both ends of the support portion 11 in the longitudinal direction of the support portion 11 and connected to the support arms 13a and 13b of the gripping portion 13, respectively, to support the gripping portion 13 in the horizontal direction. For example, the cushioning portion 15 may be applied as a shock absorber including a cylinder filled with a cushioning agent such as gas, and a rod installed in the cylinder and linearly moving in the axial direction to transmit a load to the cushioning agent. However, the cushioning portion 15 is not necessarily limited thereto, and may be modified and applied in various configurations within conditions capable of performing the same function.

On the other hand, the cargo loading unit 1 may be formed in a different shape from the above.

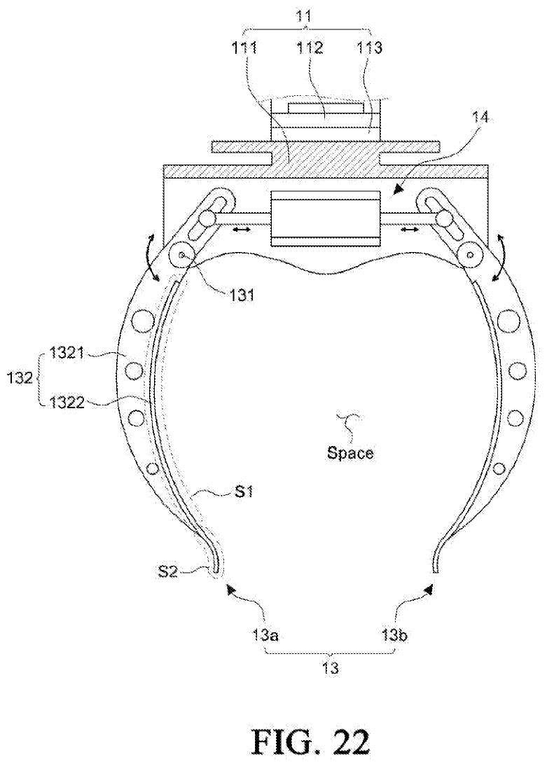

FIG. 22 is a view schematically illustrating a modified example of the cargo loading unit according to still another embodiment of the present invention.

Referring to FIGS. 20 and 22, the cargo loading unit 1 may include a support portion 11.

The support portion 11 may be formed in a plurality of structures that is installed on the hand lift device 2 to be lifted up and down and coupled to each other.

The support portion 11 may include a support member 111.

The support member 111 is provided with a driving portion 14 to be described below therein and may be rotatably coupled with the gripping portion 13 to be described below.

More specifically, the support member 111 may be formed in a structure having a ‘C’-shaped cross section to form an accommodation space for accommodating the gripping portion 13 and the driving portion 14 therein. In addition, in the support member 111, a plurality of coupling holes to which the gripping portion 13 is rotatably coupled may be formed.

The support portion 11 may include a lifting member 112 installed on the hand lift device 2 to lift up and down and a coupling member 113 connecting the support member 111 and the lifting member 112. For example, the lifting member 112 and the coupling member 113 may have protrusions and grooves corresponding to each other, and may be coupled by a male-female fitting method at the time of coupling.

Further, the cargo loading unit 1 may include the gripping portion 13.

The gripping portion 13 is formed in a tongs shape to be rotatably installed on the support portion 11 and may form an accommodation space capable of accommodating the cargo therein. In addition, the gripping portion 13 is connected with the driving portion 14 to be described below and is separated by rotating outward or retracted by rotating inward according to the driving of the driving portion 14. Accordingly, the gripping portion 13 adjusts the size of the accommodation space according to the size and appearance of the cargo to be loaded and then accommodates the cargo in the accommodation space, and presses the outer surface of the cargo accommodated in the accommodation space to grip the cargo.

In addition, the gripping portion 13 may include a first support arm 13a which is rotatably installed on one side of the support portion 11 and a second support arm 13b which is rotatably installed on the other side of the support portion 11 and disposed opposite to the first support arm 13a.

The first support arm 13a and the second support arm 13b perform relative motion through the driving portion 14 to be described below and may be rotated at a predetermined angle. For example, the first support arm 13a and the second support arm 13b may be rotated at angles between 0° and 180°.

Each of the first support arm 13a and the second support arm 13b may include a rotational shaft portion 131 which is rotatably installed on support portion 11 and disposed in the inner space of the support portion 11, and a gripping body 132 which is connected to the rotational shaft portion 131 to grip the cargo.

The gripping body 132 is coupled to the rotational shaft portion 131 so that one side may be disposed in the outer space of the support portion 11 and the other side may be disposed in the inner space of the support portion 11 to be coupled to the driving portion 14. Accordingly, the gripping body 132 may be rotated together with the rotational shaft portion 131 according to the driving of the driving unit 14 to be separated outward or retracted inward to grip the outer surface of the cargo.

In addition, the gripping body 132 may include a rotary blade 1321 and a gripping member 1322.

The rotary blade 1321 may be coupled to the rotational shaft portion 131 to be rotatable together with the rotational shaft portion 131 and a plurality of rotary blades may be provided in an axial direction of the rotational shaft portion 131 and some thereof are accommodated into the support portion 11 to be coupled to the angle adjusting portion 14. Here, one end of the driving portion 14 is coupled to a part of the rotary blade 1321 accommodated in the support portion 11, and a slot through which one end of the driving portion 14 is movable during the driving of the driving portion 14 may be formed. However, the rotary blade 1321 is not necessarily coupled to the driving portion 14 through its structure, and may be connected to the driving portion 14 through various structures within the conditions capable of performing the same function.

The gripping member 1322 is attached to the inner surface of the plurality of rotary blades 1321 and may be in close contact with the outer surface of the cargo when the cargo is loaded to support the cargo.

Here, the gripping member 1322 may be formed with a plurality of gripping surfaces.

More specifically, the gripping member 1322 is provided with a gripping surface S1 which is formed in an arc shape facing the outside in the horizontal direction (X-axis direction) to support the outer surface of the cargo, and a separation prevention surface S2 which is extended from the gripping surface S1 and formed in an arc shape facing the inside in the horizontal direction (X-axis direction) to support the end portion of the cargo. In this case, a space between the plurality of gripping surfaces S1 may be formed to be larger than the space between the plurality of separation prevention surface S2. However, the plurality of gripping surfaces formed on the gripping member 1322 is not necessarily limited thereto, but may be applied to the opposite case, or may be modified and applied into various shapes within conditions capable of performing the same function.

Meanwhile, a plurality of through holes may be formed in the gripping body 132 to reduce the weight of the gripping body 132. On the one surface of the gripping member 1322 that is in contact with the cargo, a material having a large surface resistance may be coated or attached, or a protrusion and the like may be further formed so as to more stably grip the cargo when the cargo is loaded.

Further, the cargo loading unit 1 may include the driving portion 14.

The driving portion 14 is installed on the support portion 11 to be connected with the end portion of the gripping portion 13 accommodated in the support portion 11 and pushes outwardly or pulls inwardly the end portion of the gripping portion 13 by performing the linear motion to adjust a rotational angle of the gripping portion 13.

More specifically, the driving portion 14 may be applied as a linear actuator which is connected to both the support arms 13a and 13b of the gripping portion 13 to pull inwardly or push outwardly the end portions of both the support arms 13a and 13b of the gripping portion 13 through the linear motion. For example, the linear actuator includes a linear motor installed in the center of the inside of the support portion 11, and a linear shaft which is installed in the linear motor, extended or contracted in both directions of the linear motor in the X-axis direction when the linear motor is driven to perform the linear motion, and coupled to both the support arms 13a and 13b of the gripping portion 13. However, the linear actuator is not necessarily limited thereto, and may be modified and applied in various configurations within conditions capable of performing the same function.

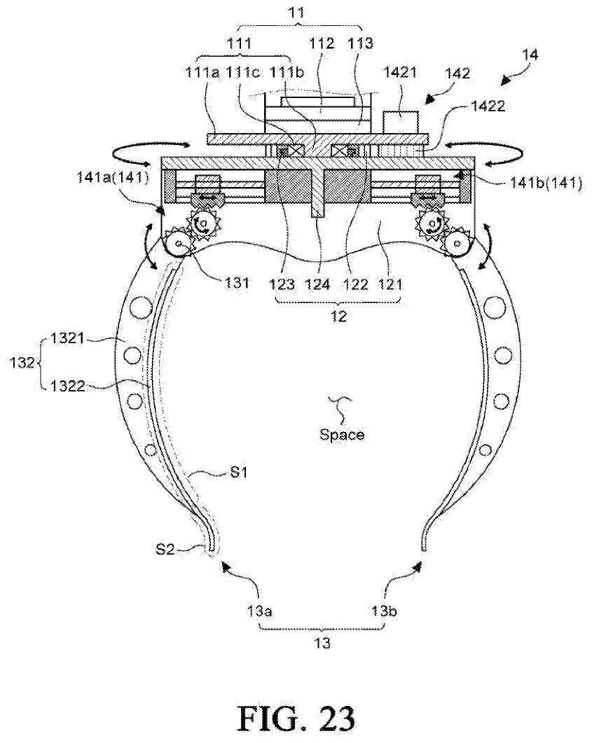

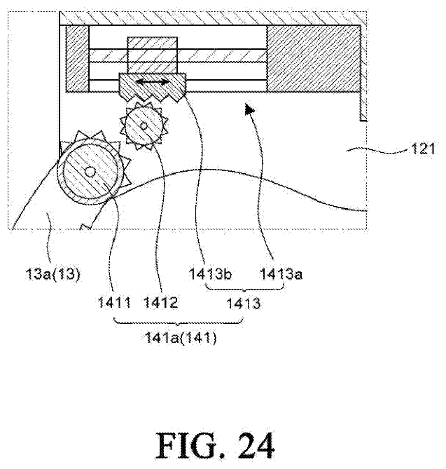

FIG. 23 is a view schematically illustrating another modified example of the cargo loading unit according to still another embodiment of the present invention and FIG. 24 is a view schematically illustrating a first angle adjusting unit of the cargo loading unit of FIG. 23.

Referring to FIGS. 20 and 23, the cargo loading unit 1 may include a support portion 11.

The support portion 11 may be formed in a plurality of structures that is installed on the hand lift device 2 to be lifted up and down and coupled to each other.

In addition, the support portion 11 may include a support member 111 which is axially coupled to a rotation portion 12 to be described below and rotatably supports the rotation portion 12.

The support member 111 may include a panel portion 111a, a shaft portion 111b, and a bearing portion 111c.

The panel portion 111a may be installed on the coupling member 113 and formed in a plate-like structure having a predetermined thickness. For example, the panel portion 111a may be formed with an upper-lower symmetrical structure in which the width of the cross section is gradually decreased toward the central portion in the vertical direction. However, the panel portion 111a is not limited thereto, and may be modified and applied into various shapes.

The shaft portion 111b may protrude from the central portion of the panel portion 111a by a predetermined length. For example, the shaft portion 111b may be integrally formed with the panel portion 111a or may be coupled to the panel portion 111a through a fastening means.

The bearing portion 111c is provided around the shaft portion 111b to support the rotation portion 12 to be described below and may distribute the axial load applied from the rotation portion 12 when the rotation portion 12 is rotated. For example, the bearing portion 111c may include an outer shell and an inner shell, a ball that performs rolling motion between the outer shell and the inner shell, and a cage that supports the ball.

The support portion 11 may include a lifting member 112 installed on the hand lift device 2 to lift up and down and a coupling member 113 connecting the support member 111 and the lifting member 112. For example, the lifting member 112 and the coupling member 113 may have protrusions and grooves corresponding to each other, and may be coupled by a male-female fitting method at the time of coupling.

Further, the cargo loading unit 1 may include the rotation portion 12.

The rotation portion 12 is installed on the support portion 11 and can be rotated clockwise or counterclockwise through the driving of the driving portion 14 to be described below or can also be rotated at a predetermined angle.

The rotation portion 12 may include a bracket 121, a driven gear 122, a gear fixing member 123, and a diaphragm 124.

The bracket 121 is formed in a structure having a ‘C’ shaped cross section to form an accommodation space for accommodating the gripping portion 13 to be described below and the first angle adjusting unit 141 of the driving portion 14. The bracket 121 is coupled to the shaft portion 111b of the support member 111 and connected to the driven gear 122 to be described below and can be rotated clockwise or counterclockwise on one side of the panel portion 111a at the time of driving a second driving portion 142 transmitting the rotational force to the driven gear 122. For example, the bracket 121 can be rotated at an angle of 0° to 360° together with the driven gear 122, and the bracket 121 may be formed with a plurality of coupling holes to which the gripping portion 13 to be described below can be coupled.

Meanwhile, the end portion of the bracket 121 facing the accommodation space may be formed to protrude forward by a predetermined length so as to support a part of the cargo when the cargo is placed in the accommodation space.

In addition, the bracket 121 may be formed in a structure that is extendable in the longitudinal direction (X-axis direction).

More specifically, the bracket 121 has an outer portion (not illustrated) which forms an outer shape and is rotatably provided on the bearing portion 111c with a driven gear 122 to be described below at one side, and an inner portion (not illustrated) which is installed inside the outer portion and linearly movable in the longitudinal direction (X-axis direction) along the inner surface of the outer portion. Here, the gripping portion 13 and the driving portion 14 to be described below are provided in the inner portion, and a power transmission means (not illustrated) provided in the outer portion to linearly move the inner portion may be provided between the outer portion and the inner portion.

Accordingly, the bracket 121 may be extended or contracted by a predetermined length in the longitudinal direction (X-axis direction) according to the transmitted control command to variably adjust the size of the accommodation space formed inside the gripping portion 13, thereby loading the cargos having more various sizes.

The driven gear 122 is disposed between the bracket 121 and the panel portion 111a and installed around the bearing portion 111c and may be rotated together with the bracket 121 when receiving the rotational force. For example, the driven gear 122 may be rotated by receiving a rotational force from the second angle adjusting unit 142 of the driving portion 14 to be described below and may be fixed to one surface of the bracket 121 through the gear fixing member 123 to be described below.

The gear fixing member 123 protrudes outward from the outer surface of the bracket 121 to be coupled to the driven gear 122, thereby fixing the driven gear 122 to the outer surface of the bracket 121. For example, the gear fixing member 123 is formed in a tubular structure in which a stepped portion is formed in the periphery and a bearing portion 111c is accommodated in the inner side and coupled to the inner surface of the driven gear 122 to support the driven gear 122 while being fixed to the outer surface of the bracket 121, thereby preventing the driven gear 122 from being separated. However, the gear fixing member 123 is not necessarily limited to the shape thereof, and may be modified and applied in various configurations within conditions capable of performing the same function.

The diaphragm 124 may be disposed at an inner central portion of the bracket 121 and protrude from the inner surface of the bracket 121 by a predetermined length. Through this, the diaphragm 124 may not only divide the internal space of the bracket 121 into a plurality of spaces but also reinforce the rigidity of the bracket 121 by supporting the inner central portion of the bracket 121 formed in a ‘C’ shape.

Further, the cargo loading unit 1 may include the gripping portion 13.

The gripping portion 13 is formed in a tongs shape to be rotatably installed on the rotation portion 12 and may form an accommodation space capable of accommodating the cargo therein. In addition, the gripping portion 13 is connected with the driving portion 14 to be described below and is separated by rotating outward or retracted by rotating inward by a rotational force received from the driving portion 14. Accordingly, the gripping portion 13 adjusts the size of the accommodation space according to the size and appearance of the cargo to be loaded and then accommodates the cargo in the accommodation space, and presses the outer surface of the cargo accommodated in the accommodation space to support the cargo.

In addition, the gripping portion 13 may include a first support arm 13a which is rotatably installed on one side of the bracket 121 and a second support arm 13b which is rotatably installed on the other side of the bracket 121 and disposed opposite to the first support arm 13a.

The first support arm 13a and the second support arm 13b perform relative motion through the driving portion 14 to be described below and may be rotated at a predetermined angle. For example, the first support arm 13a and the second support arm 13b may be rotated at angles between 0° and 180°.

Each of the first support arm 13a and the second support arm 13b may include a rotational shaft portion 131 which is rotatably installed on bracket 121 and disposed in the inner space of the bracket 121, and a gripping body 132 which is connected to the rotational shaft portion 131 to grip the cargo.

The gripping body 132 is coupled with the rotational shaft portion 131 and disposed in the outer space of the bracket 121 and may be separated outwardly or retracted inwardly by rotating together with the rotational shaft portion 131 according to the driving of the first angle adjusting unit 141 to grip the outer surface of the cargo.

In addition, the gripping body 132 may include a rotary blade 1321 and a gripping member 1322.

A plurality of rotary blades 1321 may be provided in an axial direction of the rotational shaft portion 131 and integrally coupled to the rotational shaft portion 131 to rotate together with the rotational shaft portion 131 clockwise or counterclockwise when the driving portion 14 is driven.

The gripping member 1322 is attached to the inner surface of the plurality of rotary blades 1321 and may be in close contact with the outer surface of the cargo when the cargo is loaded to support the cargo.

Here, the gripping member 1322 may be formed with a plurality of gripping surfaces.

More specifically, the gripping member 1322 is provided with a gripping surface S1 which is formed in an arc shape facing the outside in the horizontal direction (X-axis direction) to support the outer surface of the cargo, and a separation prevention surface S2 which is extended from the gripping surface S1 and formed in an arc shape facing the inside in the horizontal direction (X-axis direction) to support the end portion of the cargo. In this case, a space between the plurality of gripping surfaces S1 may be formed to be larger than the space between the plurality of separation prevention surface S2. However, the plurality of gripping surfaces formed on the gripping member 1322 is not necessarily limited thereto, but may be applied to the opposite case, or may be modified and applied into various shapes within conditions capable of performing the same function.

Meanwhile, a plurality of through holes may be formed in the gripping body 132 to reduce the weight of the gripping body 132. On the one surface of the gripping member 1322 that is in contact with the cargo, a material having a large surface resistance may be coated or attached, or a protrusion and the like may be further formed so as to more stably grip the cargo when the cargo is loaded.

Further, the gripping body 132 may be formed in a multi joint structure.

More specifically, the gripping body 132 may include a plurality of joint bodies, a link member connecting the plurality of joint bodies to each other, and a power means which is installed on the plurality of joint bodies to adjust the size between the plurality of joint bodies through the control command.

Accordingly, the gripping body 132 may perform joint motion to load cargo having various sizes and shapes, and further stably grip the outer surface of the cargo.

Further, a plurality of gripping bodies 132 are provided inside the bracket 121, and may be individually driven in a vertical direction (Z-axis direction).

Accordingly, the plurality of gripping bodies 132 may stably grip cargo having a non-uniform outer shape at a plurality of positions through separate driving.

Further, the cargo loading unit 1 may include the driving portion 14.

The driving portion 14 may be installed on the support portion 11 and the rotation portion 12 and transmit the rotational force to the rotation portion 12 and the gripping portion 13 to adjust the rotational angle of the rotation portion 12 and the gripping portion 13.

Referring to FIGS. 23 and 24, the driving portion 14 may include a first angle adjusting unit 141 and a second angle adjusting unit 142.

The first angle adjusting unit 141 includes a first arm controller 141a which is installed inside the bracket 121 to rotate the first support arm 13a and a second arm controller 141b which is provided inside the bracket 121 and disposed opposite to the first arm controller 141a to rotate the second support arm 13b.

Here, the first arm controller 141a and the second arm controller 141b may include a first power transmission gear 1411, a second power transmission gear 1412, and a first driving device 1413.

The first power transmission gear 1411 may be installed around the rotational shaft portion 131 and rotatable together with the rotational shaft portion 131.

The second power transmission gear 1412 is rotatably provided on the inside of the bracket 121 and gear-engaged with the first power transmission gear 1411 and a third power transmission gear 1413b to be described below, and transmits a rotational force to the first power transmission gear 1411 while rotating at the time of driving the first driving device 1413 to rotate the first power transmission gear 1411.

The first driving device 1413 is installed inside the bracket 121 and connected to the second power transmission gear 1412 and may perform linear motion to rotate the second power transmission gear 1412 clockwise or counterclockwise.

Here, the first driving device 1413 may include a linear actuator 1413a and a third power transmission gear 1413b.

The linear actuator 1413a is installed inside the bracket 121 and can perform linear motion in the longitudinal direction of the bracket 121. For example, the linear actuator 1413a includes a linear motor, a linear shaft which is provided on the linear motor to be rotated and has a spiral groove formed on the outer surface thereof, and a transport block which is installed on the linear shaft, linearly moves upon rotation of the linear shaft, and has a third power transmission gear 1413b installed on one surface. However, the linear actuator 1413a is not necessarily limited thereto, and may be modified and applied in various configurations within conditions capable of performing the same function.

The third power transmission gear 1413b is installed on the linear actuator 1413a to be gear-engaged with the second power transmission gear 1412 and may linearly move to one side or the other side upon driving of the linear actuator 1413a to rotate the second power transmission gear 1412. For example, the third power transmission gear 1413b may be applied as a rack gear.

The second angle adjusting unit 142 is installed on the support member 111 and may transmit the rotational force to the driven gear 122 to rotate the bracket 121.

More specifically, the second angle adjusting unit 142 may include a second driving device 1421 which is installed and fixed on the support member 111, and a drive gear 1422 which is connected to the second driving device 1421 and gear-engaged with the driven gear 122 and generates a rotational force when the second driving device 1421 is driven to rotate the driven gear 122.

Therefore, the hand lift device 2 is provided with the gripping portion 13 having a tongs shape capable of gripping the cargo by adjusting the accommodation space through the relative movement of the cargo loading unit 1, thereby easily gripping and loading the cargo having various sizes and shapes.

In addition, since the hand lift device 2 is provided with the rotation portion 12 which is rotatable clockwise or counterclockwise, the cargo can be gripped at various positions, thereby increasing the usability and efficiently loading various types of cargo.

Further, by controlling the gripping portion 13 through the driving portion 14 to which the linear actuator is applied, the pressing force suitable for the cargo is finely adjusted according to the shape of the cargo, the material of the cargo or the hardness of the cargo so as to stably load the cargo.

In addition, when the cargo is loaded, the gripping portion 13 supports the bottom surface of the cargo and supports the circumferential surface of the cargo accommodated in the accommodation space without lifting up to lower the center of gravity of the loaded cargo, thereby more stably loading the cargo.

While the embodiments of the present invention have been illustrated and described above, the present invention is not limited to the aforementioned specific embodiments, various modifications may be made by a person with ordinary skill in the technical field to which the present invention pertains without departing from the subject matters of the present invention that are claimed in the claims, and these modifications should not be appreciated individually from the technical spirit or prospect of the present invention.

1. A hand lift device comprising:
a frame portion including a vertical frame, a first sprocket installed on an upper end of the vertical frame, and a second sprocket installed on a lower end of the vertical frame;
a chain installed to engage with the first sprocket and the second sprocket;
a cargo loading unit which is connected with the chain and disposed to be liftable along the vertical frame to load cargo;
a power transmission portion which provides a driving force to the chain so that the cargo loading unit is lifted up and down;
a sensor portion which is installed in an area where the frame portion is formed to be positioned at an upper side in a range where the cargo loading unit is lifted up and down and includes a proximity sensor to sense the cargo loaded on the cargo loading unit; and
a controller which controls lifting up and down of the cargo loading unit by adjusting the driving of the power transmission portion according to a sensing signal from the sensor portion.

2. (canceled)

3. The hand lift device of claim 1, wherein the cargo loading unit includes a loading member on which the cargo is loaded, a lifting member that lifts up and down along a guide rail formed on the vertical frame, and a coupling member that couples the loading member and the lifting member, and the chain is connected to the lifting member and transmits a driving force from the power transmission portion to the cargo loading unit through the lifting member.

4. The hand lift device of claim 3, wherein one end of the chain is connected to the upper end of the lifting member, the other end of the chain is connected to the lower end of the lifting member, and a chain tensioner providing tension to the chain is interposed in at least one point of points where the chain and the lifting member are connected.

5. The hand lift device of claim 4, wherein the chain tensioner is formed of a spring member in which both ends have a ring shape, one end is connected to the chain, and the other end is connected to the lifting member, or formed in an elastic structure which includes a support panel fastened to the lifting member, a chain connection portion of which one side is exposed outside the support panel through the support panel to be coupled to the chain and the other side is accommodated inside the lifting member, and a spring member elastically supporting the chain connection portion while being accommodated inside the lifting member, interposed between the chain connection portion and the support panel, and supported by the support panel.

6. The hand lift device of claim 3, wherein the lifting member includes at least one protrusion, and the coupling member includes at least one engaging portion formed to engage with the protrusion.

7. The hand lift device of claim 1, wherein the controller controls the driving of the power transmission portion to maintain a height of the upper end of the cargo loaded on the cargo loading unit at a predetermined height based on the sensing signal from the sensor portion.

8. The hand lift device of claim 7, wherein the controller controls the lifting of the cargo loading unit by maintaining the driving of the power transmission portion when the cargo sensing signal is received from the sensor portion in the case of a load mode of driving the power transmission portion so that the cargo loading unit is lifted down, and stopping the driving of the power transmission portion when the cargo sensing signal is received from the sensor portion in the case of an unload mode of driving the power transmission portion so that the cargo loading unit is lifted up.

9. The hand lift device of claim 1, wherein the sensor portion further includes a load cell which is installed on the cargo loading unit to sense the load of the cargo loaded on the cargo loading unit.

10. The hand lift device of claim 1, further comprising:
a moving support portion which is detachably installed on the frame portion to support the frame portion and moves the frame portion to a predetermined position.

11. The hand lift device of claim 10, wherein the moving support portion includes:
a frame support structure which has a slot which can accommodate a part of the frame portion therein to support an outer surface of the frame portion accommodated in the slot and is detachably coupled to the frame portion;
support panels which are coupled to both ends of the frame support structure in a longitudinal direction of the frame support structure;
wheels which are coupled to the support panels and are arranged behind the frame portion and perform rotational motion in a state of being grounded on a ground surface; and
forks which are coupled to the support panel and disposed in front of the frame portion and have a caster at the end to switch a movement direction of the frame portion.

12.-13. (canceled)

14. The hand lift device of claim 1, further comprising:
a fixing support portion which is detachably installed on the frame portion and supported on the ground to support the frame portion in a direction perpendicular to the ground surface.

15. The hand lift device of claim 14, wherein the fixing support portion includes
a fixing panel formed in a flat plate and installed on the ground; and
a vertical support frame which protrudes upward by a predetermined length in a vertical direction from the upper surface of the fixing panel to form a slot capable of accommodating a part of the frame portion therein and support the outer surface of the frame portion accommodated in the slot.

16. (canceled)

17. The hand lift device of claim 1, further comprising:
a boarding portion which is installed on the frame portion and boardable while a user is standing or sitting.

18. The hand lift device of claim 1, wherein the cargo loading unit includes
a support frame which is installed on the frame portion to be lifted up and down;
support arms which protrude from the end of the support frame in a predetermined length to form an accommodation space capable of accommodating the cargo therein and are disposed opposite to each other in the longitudinal direction of the support frame; and
gripping blades which are rotatably installed on the support arms and disposed in the accommodation space in a horizontal state, and separated outwardly by rotating at a predetermined angle when the cargo is loaded and then retracted inwardly by an elastic force to support the outer surface of the cargo.

19. The hand lift device of claim 18, wherein the support arms and the gripping blades are relatively movable in the longitudinal direction of the support frame.

20.-24. (canceled)

25. The hand lift device of claim 18, wherein at least one of the gripping blade includes
a shaft portion rotatably coupled to the support arm;
a blade body which extends from the shaft portion to one side to be disposed in the accommodation space and has a plurality of inclined guide surfaces formed on one side end and the other side end of the blade body in the longitudinal direction to guide the movement of the cargo when the cargo is loaded; and
an elastic member which is provided around the shaft portion to elastically support the blade body and limits a rotational angle of the at least one of the gripping blades.

26.-27. (canceled)

28. The hand lift device of claim 1, wherein the cargo loading unit includes
a support frame which is installed on the frame portion to be lifted up and down;
a driving portion which is installed on the support portion and extendable or contractable by performing linear motion in a horizontal direction;
a gripping portion which is rotatably coupled to both ends of the driving portion, forms an accommodation space capable of accommodating the cargo therein, and grips the cargo accommodated in the accommodation space by performing relative motion in the horizontal direction when the driving portion is driven; and
a cushioning portion provided on the support portion and supporting the gripping portion in the horizontal direction.

29.-30. (canceled)

31. The hand lift device of claim 1, wherein the cargo loading unit includes
a support frame which is installed on the frame portion to be lifted up and down;
a tongs-shaped gripping portion which is rotatably installed on the support portion to form an accommodation space therein and grips the cargo accommodated in the accommodation space while being separated outwardly or retracted inwardly during rotating; and
a driving portion which is installed on the support portion to be connected to the end portion of the gripping portion accommodated in the support portion and pushes outwardly or pulls inwardly the end portion of the gripping portion by performing linear motion to adjust a rotational angle of the gripping portion.

32. The hand lift device of claim 1, wherein the cargo loading unit includes
a support frame which is installed on the frame portion to be lifted up and down;
a rotation portion installed on the support portion and rotatable clockwise or counterclockwise;
a tongs-shaped gripping portion which is installed on the rotation portion to form an accommodation space therein and separated outwardly or retracted inwardly by rotation and presses and supports the outer surface of the cargo accommodated in the accommodation space; and
a driving portion including a first angle adjusting unit which is installed on the rotation portion and transmits a rotational force to the gripping portion to adjust a rotational angle of the gripping portion, and a second angle adjusting unit which is installed on the support portion and transmits a rotational force to the rotation portion to adjust a rotational angle of the rotation portion.

33.-38. (canceled)
